(19) United States
(12) Patent Application Publication
(10) Pub. No.: US 2015/0365545 A1
(43) Pub. Date: Dec. 17, 2015

(54) Picture Outputting Method and Apparatus

(71) Applicant: Huawei Device Co., Ltd., Shenzhen (CN)

(72) Inventor: Lei Wu, Shenzhen (CN)

(21) Appl. No.: 14/834,735

(22) Filed: Aug. 25, 2015

Related U.S. Application Data
(63) Continuation of application No. PCT/CN2013/086054, filed on Oct. 28, 2013.

(30) Foreign Application Priority Data
Mar. 27, 2013 (CN) 201310101209.2

(51) Int. Cl. H04N 1/00; G06K 9/52; G06K 9/62; G06K 9/46; H04N 5/232; G06K 9/00

(52) U.S. Cl. CPC H04N 1/00183; H04N 5/23219; G06K 9/00268; G06K 9/6201; G06K 9/46; G06K 9/52; G06K 2009/4666

(57) ABSTRACT

A picture outputting method and apparatus are provided, where the method may include collecting photographing data by using a camera, parsing the collected photographing data to obtain a first attribute parameter, where the first attribute parameter includes the number of faces and a location of a face on a screen, matching the parsed-out first attribute parameter to a second attribute parameter of one or more pre-stored photographic pose recommendation pictures, and when a photographic pose recommendation picture is found, outputting the photographic pose recommendation picture, so that a user adjusts a photographic pose according to the photographic pose recommendation picture, where a second attribute parameter of the photographic pose recommendation picture and the first attribute parameter meet a preset matching result. Therefore, a superb photographic pose recommendation picture is output for a user.

### CROSS-REFERENCE TO RELATED APPLICATIONS

This application is a continuation of International Application No. PCT/CN2013/086054, filed on Oct. 28, 2013, which claims priority to Chinese Patent Application No. 201310101209.2, filed on Mar. 27, 2013, both of which are hereby incorporated by reference in their entireties.

### TECHNICAL FIELD

The present disclosure relates to the communications field, and in particular, to a picture outputting method and apparatus.

### BACKGROUND

A camera is already capable of making precise determining on a photographed face, and can detect a location of the face, the number of persons, whether a smile is on the face, and whether eyes are closed. Now, modes, such as smile photographing and open-eye photographing, are commonly used in a digital camera. In such modes, even if a shutter is pressed, the camera can also intelligently take a photo only when it is detected that there is a smiling face or eyes are not closed. However, in current photographing technologies, an image recognition function of a camera is only used for focusing and smart adjustment of photographing time.

### SUMMARY

Embodiments of the present disclosure provide a picture outputting method and apparatus which can output a superb photographic pose recommendation picture for a user.

A first aspect of the present disclosure provides a picture outputting method, which may include collecting photographing data by using a camera, parsing the collected photographing data to obtain a first attribute parameter, where the first attribute parameter includes the number of faces and a location of a face on a screen, matching the parsed-out first attribute parameter to a second attribute parameter of one or more pre-stored photographic pose recommendation pictures, and when a photographic pose recommendation picture is found, outputting the photographic pose recommendation picture, so that a user adjusts a photographic pose according to the photographic pose recommendation picture, where a second attribute parameter of the photographic pose recommendation picture and the first attribute parameter meet a preset matching result.

With reference to the first aspect, in a first possible implementation manner, the matching the parsed-out first attribute parameter to a second attribute parameter of one or more pre-stored photographic pose recommendation pictures includes matching the parsed-out number of faces to the number of faces included in the one or more pre-stored photographic pose recommendation pictures, when a photographic pose recommendation picture in which the number of included faces is the same as the parsed-out number of faces is found, determining whether a location of each face on the screen in the photographic pose recommendation picture is the same as the parsed-out location of a face on the screen, and if a determining result is that the location of each face on the screen in the photographic pose recommendation picture is the same as the parsed-out location of a face on the screen, determining that the photographic pose recommendation picture is found, where the second attribute parameter of the photographic pose recommendation picture and the first attribute parameter meet the preset matching result.

With reference to the first aspect, in a second possible implementation manner, the first attribute parameter further includes a size of a face in each location, and the matching the parsed-out first attribute parameter to a second attribute parameter of one or more pre-stored photographic pose recommendation pictures includes matching the parsed-out number of faces to the number of faces included in the one or more pre-stored photographic pose recommendation pictures, when a photographic pose recommendation picture in which the number of included faces is the same as the parsed-out number of faces is found, determining whether a location of each face on the screen in the photographic pose recommendation picture is the same as the parsed-out location of a face on the screen, and if a determining result is that the location of each face on the screen in the photographic pose recommendation picture is the same as the parsed-out location of a face on the screen, determining whether a size of a face in each location in the photographic pose recommendation picture is the same as the parsed-out size of a face in each location, and if a determining result is that the size of a face in each location in the photographic pose recommendation picture is the same as the parsed-out size of a face in each location, determining that the photographic pose recommendation picture is found, where the second attribute parameter of the photographic pose recommendation picture and the first attribute parameter meet the preset matching result.

With reference to the first aspect, in a third possible implementation manner, the first attribute parameter further includes a facial angle in each location, and the matching the parsed-out first attribute parameter to a second attribute parameter of one or more pre-stored photographic pose recommendation pictures includes matching the parsed-out number of faces to the number of faces included in the one or more pre-stored photographic pose recommendation pictures, when a photographic pose recommendation picture in which the number of included faces is the same as the parsed-out number of faces is found, determining whether a location of each face on the screen in the photographic pose recommendation picture is the same as the parsed-out location of a face on the screen, and if a determining result is that the location of each face on the screen in the photographic pose recommendation picture is the same as the parsed-out location of a face on the screen, determining whether a facial angle in each location in the photographic pose recommendation picture is the same as the parsed-out facial angle in each location, and if a determining result is that the facial angle in each location in the photographic pose recommendation picture is the same as the parsed-out facial angle in each location, determining that the photographic pose recommendation picture is found, where the second attribute parameter of the photographic pose recommendation picture and the first attribute parameter meet the preset matching result.

With reference to the first aspect or any one of the first possible implementation manner to the third possible implementation manner of the first aspect, in a fourth possible implementation manner, one found photographic pose recommendation picture is randomly output when multiple photographic pose recommendation pictures of which second attribute parameters match the first attribute parameter are found.

With reference to any one of the first aspect to the third possible implementation manner of the first aspect, in a fifth possible implementation manner, the outputting the found photographic pose recommendation picture includes superimposing the found photographic pose recommendation picture in a semitransparent manner on the photographing data collected by the camera.

A second aspect of the present disclosure provides a picture outputting apparatus, which may include a photographing module configured to collect photographing data, a parsing module configured to parse the photographing data collected by the photographing module to obtain a first attribute parameter, where the first attribute parameter includes the number of faces and a location of a face on a screen, a matching module configured to match the first attribute parameter parsed out by the parsing module to a second attribute parameter of one or more pre-stored photographic pose recommendation pictures, and a display output module configured to, when the matching module finds a photographic pose recommendation picture, output the found photographic pose recommendation picture, so that a user adjusts a photographic pose according to the photographic pose recommendation picture, where a second attribute parameter of the photographic pose recommendation picture and the first attribute parameter meet a preset matching result.

With reference to the second aspect, in a first possible implementation manner, the matching module includes a first matching submodule configured to match the parsed-out number of faces to the number of faces included in the one or more pre-stored photographic pose recommendation pictures, a second matching submodule configured to, when the first matching submodule finds a photographic pose recommendation picture in which the number of included faces is the same as the parsed-out number of faces, determine whether a location of each face on the screen in the photographic pose recommendation picture is the same as the parsed-out location of a face on the screen, and a first determining submodule configured to, when a determining result of the second matching submodule is that the location of each face on the screen in the photographic pose recommendation picture is the same as the parsed-out location of a face on the screen, determine that the photographic pose recommendation picture is found, where the second attribute parameter of the photographic pose recommendation picture and the first attribute parameter meet the preset matching result.

With reference to the second aspect, in a second possible implementation manner, the first attribute parameter further includes a size of a face in each location; and the matching module includes a first matching submodule configured to match the parsed-out number of faces to the number of faces included in the one or more pre-stored photographic pose recommendation pictures, a second matching submodule configured to when the first matching submodule finds a photographic pose recommendation picture in which the number of included faces is the same as the parsed-out number of faces, determine whether a location of each face on the screen in the photographic pose recommendation picture is the same as the parsed-out location of a face on the screen, a third matching module configured to, when a determining result of the second matching submodule is that the location of each face on the screen in the photographic pose recommendation picture is the same as the parsed-out location of a face on the screen, determine whether a size of a face in each location in the photographic pose recommendation picture is the same as the parsed-out size of a face in each location, and a second determining submodule configured to, when a determining result of the third matching module is that the size of a face in each location in the photographic pose recommendation picture is the same as the parsed-out size of a face in each location, determine that the photographic pose recommendation picture is found, where the second attribute parameter of the photographic pose recommendation picture and the first attribute parameter meet the preset matching result.

With reference to the second aspect, in a third possible implementation manner, the first attribute parameter further includes a facial angle in each location; and the matching module includes a first matching submodule configured to match the parsed-out number of faces to the number of faces included in the one or more pre-stored photographic pose recommendation pictures, a second matching submodule configured to, when the first matching submodule finds a photographic pose recommendation picture in which the number of included faces is the same as the parsed-out number of faces, determine whether a location of each face on the screen in the photographic pose recommendation picture is the same as the parsed-out location of a face on the screen, a fourth matching submodule configured to, when a determining result of the second matching submodule is that the location of each face on the screen in the photographic pose recommendation picture is the same as the parsed-out location of a face on the screen, determine whether a facial angle in each location in the photographic pose recommendation picture is the same as the parsed-out facial angle in each location, and a third determining submodule configured to, when a determining result of the fourth matching submodule is that the facial angle in each location in the photographic pose recommendation picture is the same as the parsed-out facial angle in each location, determine that the photographic pose recommendation picture is found, where the second attribute parameter of the photographic pose recommendation picture and the first attribute parameter meet the preset matching result.

With reference to any one of the second aspect to the third possible implementation manner of the second aspect, in a fourth possible implementation manner, the display output module is configured to randomly output one found photographic pose recommendation picture when the matching module finds multiple photographic pose recommendation pictures of which second attribute parameters match the first attribute parameter.

With reference to any one of the second aspect to the third possible implementation manner of the second aspect, in a fifth possible implementation manner, the display output module superimposes the found photographic pose recommendation picture in a semitransparent manner on the photographing data collected by the photographing module.

A third aspect of the present disclosure provides a picture outputting apparatus, including a camera configured to collect photographing data, a processor configured to parse the photographing data collected by the camera to obtain a first attribute parameter, where the first attribute parameter includes the number of faces and a location of a face on a screen; and match the parsed-out first attribute parameter to a second attribute parameter of one or more pre-stored photographic pose recommendation pictures, and a display configured to, when the processor finds a photographic pose recommendation picture, output the photographic pose recommendation picture, so that a user adjusts a photographic pose according to the photographic pose recommendation picture, where a second attribute parameter of the photographic pose recommendation picture and the first attribute parameter meet a preset matching result.

With reference to the third aspect, in a first possible implementation manner, when matching the parsed-out first attribute parameter to the second attribute parameter of the one or more pre-stored photographic pose recommendation pictures, the processor is configured to match the parsed-out number of faces to the number of faces included in the one or more pre-stored photographic pose recommendation pictures; when a photographic pose recommendation picture in which the number of included faces is the same as the parsed-out number of faces is found, determine whether a location of each face on the screen in the photographic pose recommendation picture is the same as the parsed-out location of a face on the screen; and if a determining result is that the location of each face on the screen in the photographic pose recommendation picture is the same as the parsed-out location of a face on the screen, determine that the photographic pose recommendation picture is found, where the second attribute parameter of the photographic pose recommendation picture and the first attribute parameter meet the preset matching result.

With reference to the third aspect, in a second possible implementation manner, the first attribute parameter further includes a size of a face in each location, and, when matching the parsed-out first attribute parameter to the second attribute parameter of the one or more pre-stored photographic pose recommendation pictures, the processor is configured to match the parsed-out number of faces to the number of faces included in the one or more pre-stored photographic pose recommendation pictures, when a photographic pose recommendation picture in which the number of included faces is the same as the parsed-out number of faces is found, determine whether a location of each face on the screen in the photographic pose recommendation picture is the same as the parsed-out location of a face on the screen, and if a determining result is that the location of each face on the screen in the photographic pose recommendation picture is the same as the parsed-out location of a face on the screen, determine whether a size of a face in each location in the photographic pose recommendation picture is the same as the parsed-out size of a face in each location, and if a determining result is that the size of a face in each location in the photographic pose recommendation picture is the same as the parsed-out size of a face in each location, determine that the photographic pose recommendation picture is found, where the second attribute parameter of the photographic pose recommendation picture and the first attribute parameter meet the preset matching result.

With reference to the third aspect, in a third possible implementation manner, the first attribute parameter further includes a facial angle in each location, and, when matching the parsed-out first attribute parameter to the second attribute parameter of the one or more pre-stored photographic pose recommendation pictures, the processor is configured to match the parsed-out number of faces to the number of faces included in the one or more pre-stored photographic pose recommendation pictures, when a photographic pose recommendation picture in which the number of included faces is the same as the parsed-out number of faces is found, determine whether a location of each face on the screen in the photographic pose recommendation picture is the same as the parsed-out location of a face on the screen, and if a determining result is that the location of each face on the screen in the photographic pose recommendation picture is the same as the parsed-out location of a face on the screen, determine whether a facial angle in each location in the photographic pose recommendation picture is the same as the parsed-out facial angle in each location, and if a determining result is that the facial angle in each location in the photographic pose recommendation picture is the same as the parsed-out facial angle in each location, determine that the photographic pose recommendation picture is found, where the second attribute parameter of the photographic pose recommendation picture and the first attribute parameter meet the preset matching result.

With reference to any one of the third aspect to the third possible implementation manner of the third aspect, in a fourth possible implementation manner, the display randomly outputs one found photographic pose recommendation picture when the processor finds multiple photographic pose recommendation pictures of which second attribute parameters match the first attribute parameter.

With reference to any one of the third aspect to the third possible implementation manner of the third aspect, in a fifth possible implementation manner, the display is configured to superimpose the found photographic pose recommendation picture in a semitransparent manner on the photographing data collected by the camera.

It can be seen from the foregoing that, in some feasible implementation manners of the present disclosure, photographing data is collected by using a photographing module (camera); the collected photographing data is parsed to obtain a first attribute parameter, where the first attribute parameter includes the number of faces and a location of a face on a screen; matching is performed between the parsed-out first attribute parameter and a second attribute parameter of one or more pre-stored photographic pose recommendation pictures; and when a photographic pose recommendation picture is found, the photographic pose recommendation picture is output, so that a user adjusts a photographic pose according to the photographic pose recommendation picture, where a second attribute parameter of the photographic pose recommendation picture and the first attribute parameter meet a preset matching result. In this way, a superb photographic pose recommendation picture can be output for a user.

### BRIEF DESCRIPTION OF DRAWINGS

FIG. 1 is a schematic flowchart of Embodiment 1 of a picture outputting method according to the present disclosure.

FIG. 2 is a schematic diagram of an embodiment of principles of dividing a face location scope according to the present disclosure.

FIG. 2.1 is a schematic diagram of another embodiment of principles of dividing a face location scope according to the present disclosure.

FIG. 3 is a schematic diagram of an embodiment of principles of representing a face size according to the present disclosure.

FIG. 4 is a schematic diagram of an embodiment of photographing data collected by a camera according to the present disclosure.

FIG. 5 is a schematic expression diagram of an embodiment of a photographic pose recommendation picture according to the present disclosure.

FIG. 5.1 is a schematic diagram of a display effect of an output picture according to the present disclosure.

FIG. 6 is a schematic flowchart of Embodiment 2 of a picture outputting method according to the present disclosure.

FIG. 7 is a schematic diagram of an embodiment of photographing data collected by a camera according to the present disclosure.

FIG. 8 is a schematic diagram of an embodiment of photographing data collected by a camera according to the present disclosure.

FIG. 9 is a schematic diagram of an embodiment of a photographic pose recommendation picture according to the present disclosure.

FIG. 10 is a schematic diagram of an embodiment of a photographic pose recommendation picture according to the present disclosure.

FIG. 10.1 is a schematic flowchart of Embodiment 2 of a picture outputting method according to the present disclosure.

FIG. 11 is a schematic flowchart of Embodiment 3 of a picture outputting method according to the present disclosure.

FIG. 12 is a schematic flowchart of Embodiment 4 of a picture outputting method according to the present disclosure.

FIG. 13 is a schematic diagram of structural composition of an embodiment of a picture outputting apparatus according to the present disclosure.

FIG. 14 is a schematic diagram of structural composition of an embodiment of a matching module according to the present disclosure.

FIG. 15 is a schematic diagram of structural composition of an embodiment of a matching module according to the present disclosure.

FIG. 16 is a schematic diagram of structural composition of an embodiment of a matching module according to the present disclosure.

FIG. 17 is a schematic diagram of structural composition of an embodiment of a picture outputting apparatus according to the present disclosure.

### DESCRIPTION OF EMBODIMENTS

To make the objectives, technical solutions, and advantages of the present disclosure clearer, the following further describes the present disclosure in detail with reference to the accompanying drawings.

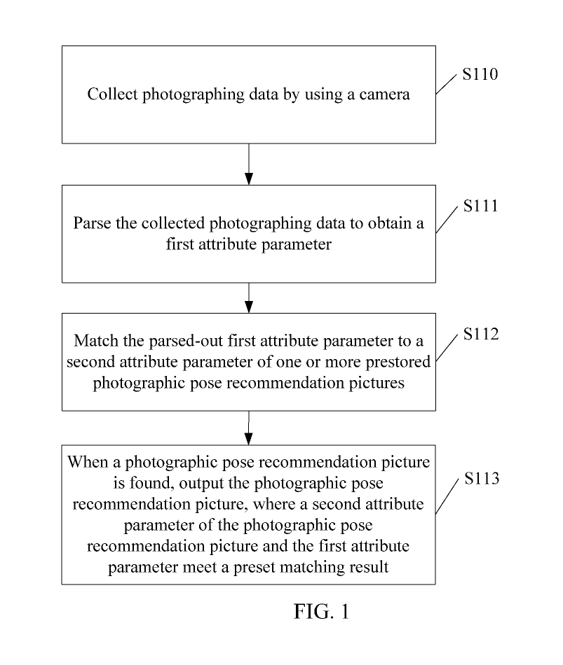

FIG. 1 is a schematic flowchart of Embodiment 1 of a picture outputting method according to the present disclosure. As shown in FIG. 1, the method may include the following steps. Step S110: Collect photographing data by using a camera.

In specific implementation, when a photo is taken (such as selfie) by using a photographing apparatus such as a mobile phone or a camera, objects before a lens, such as the number of faces, a size of a face, a location of a face on a screen, a facial angle, and the like, can be captured by using the camera.

Step S111: Parse the collected photographing data to obtain a first attribute parameter.

In some feasible implementation manners, the first attribute parameter includes the number of faces and the location of a face on the screen that are collected by the camera. In some other embodiments, the attribute parameter may further include a size of a face in each location, or a facial angle in each location, or both and the like.

In specific implementation of this embodiment of the present disclosure, multiple graceful photographic pose recommendation pictures may be pre-stored in the photographing apparatus, parameters (the number of included faces, a location of a face on a screen, a size of a face in each location, a facial angle in each location, and the like) in each picture are defined, and the defined parameters are saved as a second attribute parameter of the picture.

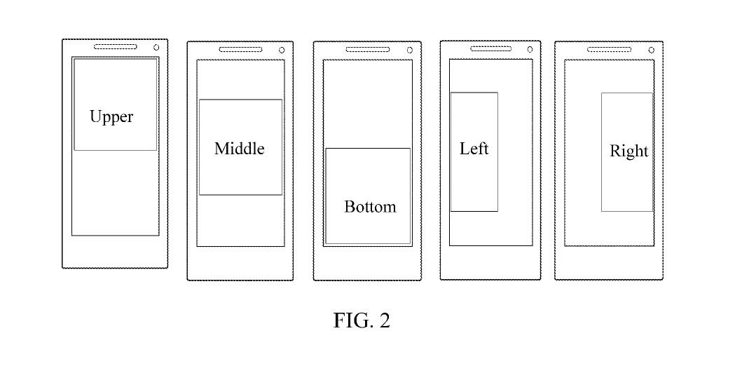

In some feasible implementation manners, in the first attribute parameter, or the second attribute parameter, or the both, the location of a face on a screen may be a location scope. For example, the screen may be divided into multiple areas such as upper, lower, left, right and middle areas (for example, as shown in FIG. 2), or more detailed areas shown by boxes in FIG. 2.1. In another feasible implementation manner, in the first attribute parameter, or the second attribute parameter, or the both, the location of a face on the screen may be specific location coordinates.

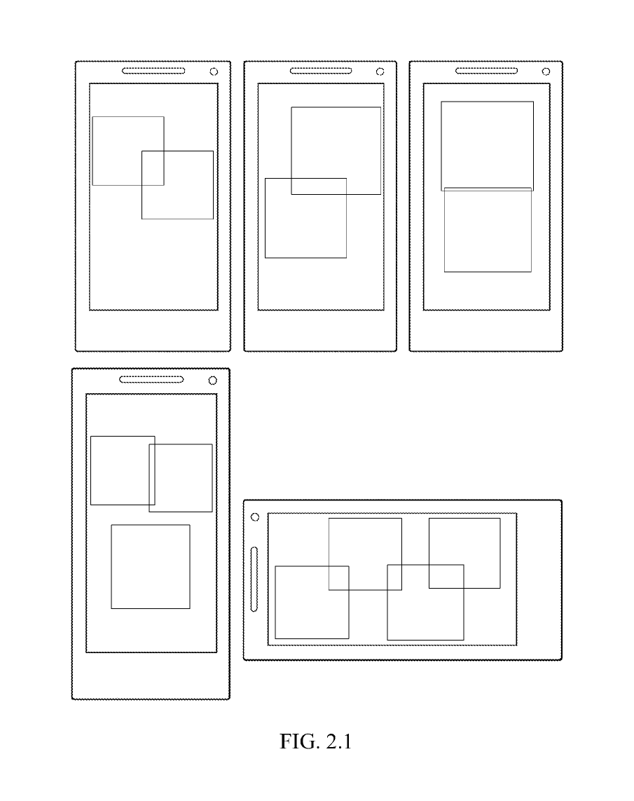

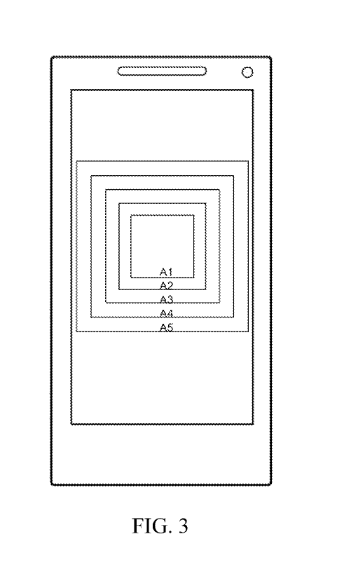

Correspondingly, in some feasible implementation manners, in the first attribute parameter, or the second attribute parameter, or the both, the size of a face in each location may be represented by an interval range of the screen. For example, when the location of a face on the screen is a location scope of a divided area, each area of the screen is divided into boxes of multiple sizes, and each box represents an interval range. In this way, a box size may be used to represent the size of a face in each location. For example, as shown in FIG. 3, a middle area of the screen may be divided into five boxes: A1, A2, A3, A4, and A5, whose sizes are in ascending order. Therefore, the size of a face in the middle area location of the screen may be represented by A1, greater than A1 but less than A2, greater than A2 but less than A3, greater than A3 but less than A4, or greater than A4 but less than A5 (the size of the face in FIG. 4 is greater than A2 but less than A3). In some other feasible implementation manners, in the first attribute parameter, or the second attribute parameter, or the both, the size of a face in each location may also be represented by parameters, such as actual length, width, and height.

In some feasible implementation manners, in the first attribute parameter, or the second attribute parameter, or the both, the facial angle in each location may be an angle value, for example, frontal, full profile, or 45° profile; or the facial angle may be an angle range, for example, frontal, 0-45° left profile, or 0-45° right profile.

Certainly, in specific implementation, the location, size and angle of a face on a screen may also be represented in other manners, which are not enumerated herein exhaustively.

Step S112: Match the parsed-out first attribute parameter to a second attribute parameter of one or more pre-stored photographic pose recommendation pictures.

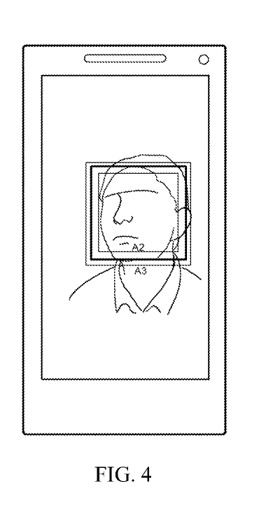

In specific implementation, different matching rules may be set according to different parameter content that is included in the first attribute parameter and the second attribute parameter. A matching sequence of attribute parameter matching and a specific parameter that needs to be matched in step S112 may be different, and standards for determining whether a preset matching result is met may also be different. For example, when the first attribute parameter and the second attribute parameter include the number of faces and the location of a face on a screen that are collected by the camera, parameters that need to be matched are only the number of faces and the location of a face on the screen. If the number of faces included in the photographing data is the same as the number of faces included in a photographic pose recommendation picture, and if a location of each face in the photographing data is also the same as a location of each face in the photographic pose recommendation picture, it may be determined that a photographic pose recommendation picture is found, where a second attribute parameter of the photographic pose recommendation picture and the first attribute parameter obtained by parsing the photographing data meet a preset matching result. However, when the first attribute parameter and the second attribute parameter include the number of faces, the location of a face on a screen, and the size of a face in each location that are collected by the camera, parameters that need to be matched in step S112 are also the three. If the number of faces included in the photographing data is the same as the number of faces included in a photographic pose recommendation picture, the location of each face in the photographing data is also the same as a location of each face in the photographic pose recommendation picture, and the size of a face in each location in the photographing data is also the same as that in the photographic pose recommendation picture, it may be determined that a photographic pose recommendation picture is found, where a second attribute parameter of the photographic pose recommendation picture and the first attribute parameter obtained by parsing the photographing data meet a preset matching result. In specific implementation, when the location of a face on a screen in the first attribute parameter and/or the second attribute parameter is specific location coordinates, and when matching is performed between the first attribute parameter and the second attribute parameter with regard to the location of a face on the screen, sameness of the location may refer to sameness of specific location coordinates; when the location of a face on a screen in the first attribute parameter and/or the second attribute parameter is a location scope, and when matching is performed between the first attribute parameter and the second attribute parameter with regard to the location of a face on the screen, sameness of the location may refer to being in a same location scope, for example, corresponding to FIG. 2, both being located on the left side, the right side, or the like of the screen. In specific implementation, when the size of a face in each location is represented by an interval range of the screen, and when matching is performed between the first attribute parameter and the second attribute parameter with regard to the size of a face in each location, sameness of the size may refer to being located in a same interval range of the screen. For example, corresponding to FIG. 4 (photographing data collected by the camera) and FIG. 5 (a pre-stored photographic pose recommendation picture), sameness of the size may refer to being located in a same interval in which the size is greater than A2 but less than A3. When the size of a face in each location is represented by parameters, such as actual length and width or height, and when matching is performed between the first attribute parameter and the second attribute parameter with regard to the size of a face in each location, sameness of the size may refer to sameness of length and width or height.

Step S113: When a photographic pose recommendation picture is found, output the photographic pose recommendation picture, so that a user adjusts a photographic pose according to the photographic pose recommendation picture, where a second attribute parameter of the photographic pose recommendation picture and the first attribute parameter meet a preset matching result.

In some feasible implementation manners, in step S113, the photographic pose recommendation picture may be superimposed in a semitransparent manner on the photographing data collected by the camera (as shown in FIG. 5.1, the frontal face is the photographing data collected by the camera, and the profile face is the photographic pose recommendation picture). On one hand, interference caused by the photographic pose recommendation picture to the photographing data collected by the camera can be reduced; on the other hand, it is convenient for the user to adjust his/her photographic pose by comparing the two pictures.

In some feasible implementation manners, multiple photographic pose recommendation pictures may meet the matching result. Therefore, in step S113, when multiple photographic pose recommendation pictures of which the first attribute parameters match the second attribute parameter of the photographing data are found, one found photographic pose recommendation picture may be randomly output.

It can be seen from the foregoing that, in some feasible implementation manners, photographing data is collected by using a camera; the collected photographing data is parsed to obtain a first attribute parameter, where the first attribute parameter includes the number of faces and a location of a face on a screen; matching is performed between the parsed-out first attribute parameter and a second attribute parameter of one or more pre-stored photographic pose recommendation pictures; and when a photographic pose recommendation picture is found, the photographic pose recommendation picture is output, so that a user adjusts a photographic pose according to the photographic pose recommendation picture, where a second attribute parameter of the photographic pose recommendation picture and the first attribute parameter meet a preset matching result. In this way, a superb photographic pose recommendation picture can be output for a user.

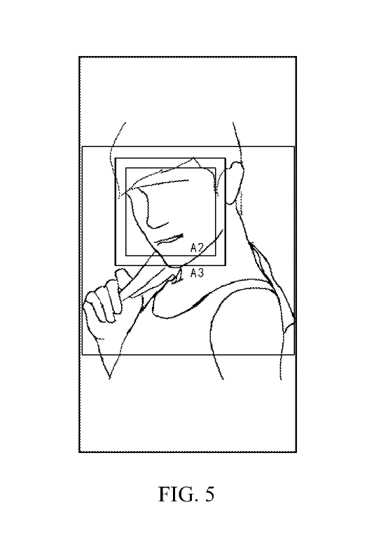

FIG. 6 is a schematic flowchart of Embodiment 2 of a picture outputting method according to the present disclosure. As shown in FIG. 6, the method may include the following steps. Step S210: Collect photographing data by using a camera.

In specific implementation, when a photo is taken (such as selfie) by using a photographing apparatus such as a mobile phone or a camera, objects before a lens, such as the number of faces, a size of a face, a location of a face on a screen, a facial angle, and the like, can be captured by using the camera.

Step S211: Parse the collected photographing data to obtain a first attribute parameter, where the first attribute parameter includes the number of faces and a location of a face on a screen that are collected by the camera.

In specific implementation of this embodiment of the present disclosure, multiple graceful photographic pose recommendation pictures may be pre-stored in the photographing apparatus, parameters (the number of included faces, a location of a face on a screen, a size of a face in each location, a facial angle in each location, and the like) in each picture are defined, and the defined parameters are saved as a second attribute parameter of the picture.

In some feasible implementation manners, in the first attribute parameter, or the second attribute parameter, or the both, the location of a face on a screen may be a location scope. For example, the screen may be divided into multiple areas such as upper, lower, left, right and middle areas (for example, as shown in FIG. 2), or divided into other areas (for example, those shown in FIG. 2.1). In another feasible implementation manner, the location of a face on the screen may be specific location coordinates.

In some feasible implementation manners, in the first attribute parameter, or the second attribute parameter, or the both, the size of a face in each location may be represented by an interval range of the screen. For example, when the location of a face on the screen is an area, each area of the screen is divided into boxes of multiple sizes in the area scope, and each box represents an interval range. A box size may be used to represent the size of a face in each location. For example, as shown in FIG. 3, a middle area of the screen may be divided into five boxes: A1, A2, A3, A4, and A5, whose sizes are in ascending order. Therefore, the size of a face in the middle area location of the screen may be represented by A1, greater than A1 but less than A2, greater than A2 but less than A3, greater than A3 but less than A4, or greater than A4 but less than A5 (the size of the face in FIG. 4 is greater than A2 but less than A3). In some other feasible implementation manners, the size of a face in each location may also be represented by parameters, such as actual length, width/height. The facial angle may be an angle value, for example, frontal, full profile, or 45° profile; or the facial angle may be an angle range, for example, frontal, 0-45° left profile, or 0-45° right profile.

Certainly, in specific implementation, the location, size and angle of a face on a screen may also be represented in other manners, which are not enumerated herein exhaustively.

Step S212: Match the parsed-out number of faces to the number of faces included in one or more pre-stored photographic pose recommendation pictures.

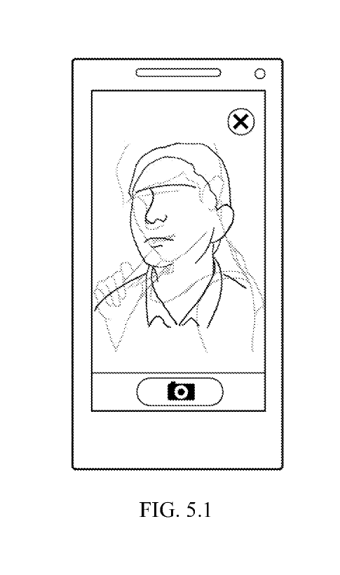

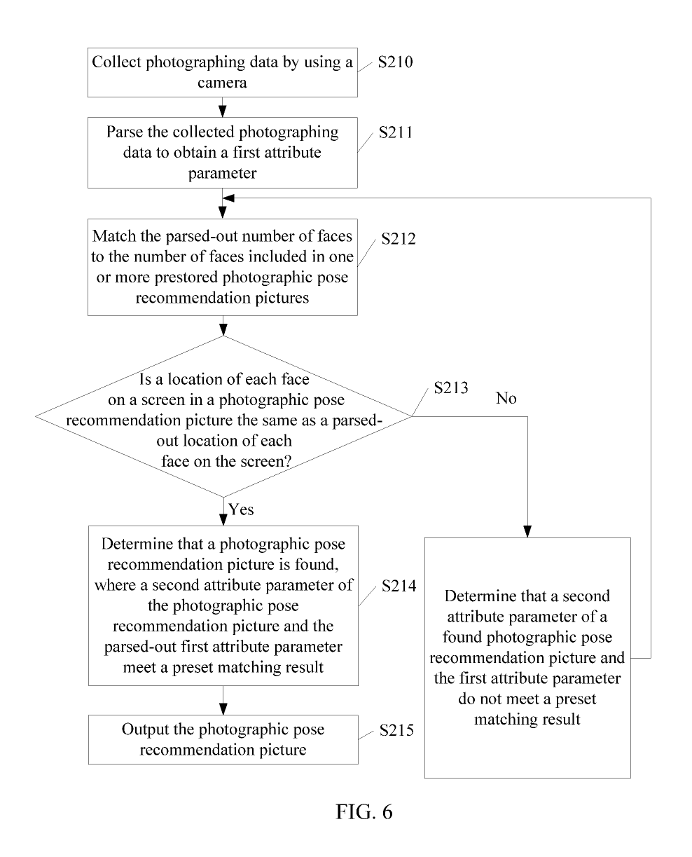

In specific implementation, the number of faces collected by the camera may be one or more. For example, FIG. 7 shows a viewfinder frame in which the camera collects a single face; and FIG. 8 shows a viewfinder frame in which the camera collects two faces. With reference to FIG. 7 and FIG. 8, in step S212, matching is performed to determine whether there is a photographic pose recommendation picture including a single face or two faces.

Step S213: When a photographic pose recommendation picture in which the number of included faces is the same as the parsed-out number of faces is found, determine whether a location of each face on the screen in the photographic pose recommendation picture is the same as the parsed-out location of each face on the screen; if a determining result is that the location of each face on the screen in the photographic pose recommendation picture is the same as the parsed-out location of each face on the screen, perform step S214.

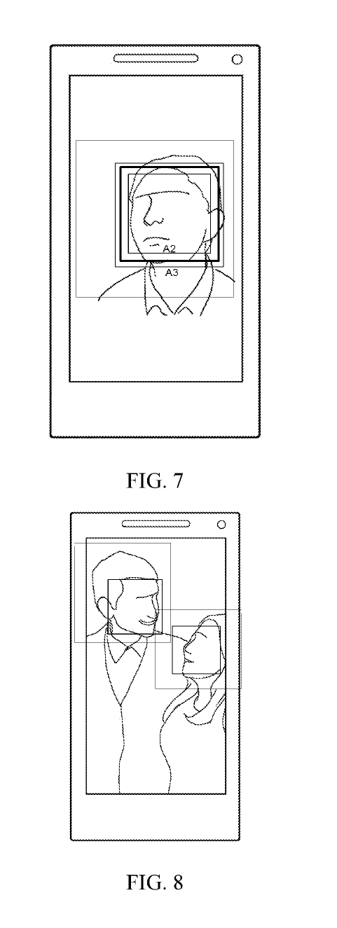

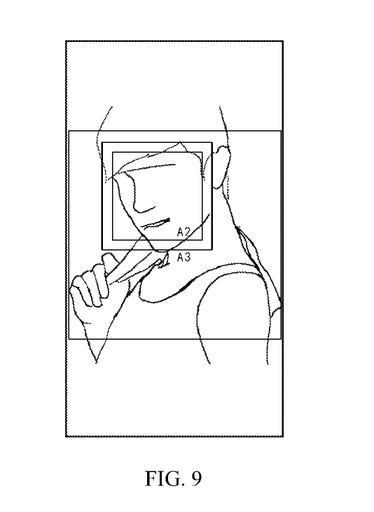

With reference to instances in FIG. 7 and FIG. 8, after a photographic pose recommendation picture including a single face or two faces is found in step S212, the photographic pose recommendation picture corresponding to a single face is shown in FIG. 9, and the photographic pose recommendation picture corresponding to two faces is shown in FIG. 10. Therefore, in step S213, it may be further determined whether the location of a face on the screen in FIG. 9 is the same as the location of a face on the screen in FIG. 7, and it may be determined whether the location of each face on the screen in FIG. 10 is the same as the location of each face on the screen in FIG. 8. Referring to FIG. 2, FIG. 7 and FIG. 9, it can be learned that, in the photographing data in FIG. 7, the location of a face on the screen is a middle area; and in the photographic pose recommendation picture in FIG. 9, the location of a face on the screen is also a middle area. It thus can be learned that the location of a single face on the screen in the photographic pose recommendation picture in FIG. 9 is the same as the location of a single face on the screen in the photographing data in FIG. 7. Therefore, in step S214, for the photographing data in FIG. 7, it may be determined that a photographic pose recommendation picture is found, where a second attribute parameter of the photographic pose recommendation picture and the first attribute parameter obtained by parsing the photographing data meet a preset matching result.

In specific implementation, it is also possible that the photographic pose recommendation picture in FIG. 9 meets a matching requirement of the number of faces but does not meet a matching requirement of the location. In this case, a system may determine whether all the pre-stored photographic pose recommendation pictures have been traversed. If a determining result is that all pre-stored photographic pose recommendation pictures have not been traversed, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, referring to FIG. 2.1, FIG. 8 and FIG. 10, it can be learned that the locations of two faces on the screen in FIG. 8 respectively correspond to the locations shown in the diagram on the upper left side of FIG. 2.1, and the locations of two faces on the screen in FIG. 10 also correspond to the locations shown in the diagram on the upper left side of FIG. 2.1. Therefore, both the locations of the two faces on the screen in the photographic pose recommendation picture in FIG. 10 are the same as the locations of the two faces on the screen in the photographing data in FIG. 8. Therefore, in step S214, for the photographing data in FIG. 8, it may be determined that a photographic pose recommendation picture shown in FIG. 10 is found, where a second attribute parameter of the photographic pose recommendation picture and the first attribute parameter obtained by parsing the photographing data meet a preset matching result.

In specific implementation, it is also possible that the photographic pose recommendation picture in FIG. 10 meets a matching requirement of the number of faces but does not meet a matching requirement of the location. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

Step S214: Determine that a photographic pose recommendation picture is found, where a second attribute parameter of the photographic pose recommendation picture and the parsed-out first attribute parameter meet a preset matching result.

Step S215: When the photographic pose recommendation picture is found, output the photographic pose recommendation picture, where the second attribute parameter of the photographic pose recommendation picture and the parsed-out first attribute parameter meet the preset matching result.

In some feasible implementation manners, in step S215, the photographic pose recommendation picture may be superimposed in a semitransparent manner on the photographing data collected by the camera (as shown in FIG. 5.1, the frontal face is the photographing data collected by the camera, and the profile face is the photographic pose recommendation picture; as shown in FIG. 10.1, the two persons hugging and facing each other are a photographic pose recommendation picture). On one hand, interference caused by the photographic pose recommendation picture to the photographing data collected by the camera can be reduced; on the other hand, it is convenient for the user to adjust his/her photographic pose by comparing the two pictures.

In some feasible implementation manners, multiple photographic pose recommendation pictures may meet the matching result. Therefore, in step S215, when multiple photographic pose recommendation pictures of which second attribute parameters match the first attribute parameter are found, one found photographic pose recommendation picture may be randomly output.

It can be seen from the foregoing that, in some feasible implementation manners, photographing data is collected by using a camera; the collected photographing data is parsed to obtain a first attribute parameter, where the first attribute parameter includes the number of faces and a location of a face on a screen that are collected by the camera; matching is performed between the parsed-out first attribute parameter and a second attribute parameter of one or more pre-stored photographic pose recommendation pictures; and when a photographic pose recommendation picture of which a second attribute parameter matches the parsed-out first attribute parameter is found, the found photographic pose recommendation picture is output, so that a user adjusts a photographic pose according to the photographic pose recommendation picture. In this way, a superb photographic pose recommendation picture can be output for a user.

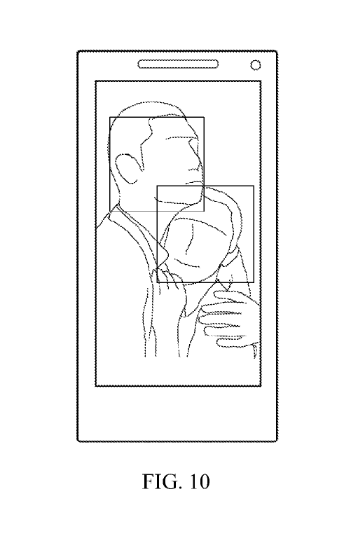

FIG. 11 is a schematic flowchart of Embodiment 3 of a picture outputting method according to the present disclosure. As shown in FIG. 11, the method may include the following steps. Step S310: Collect photographing data by using a camera.

In specific implementation, when a photo is taken (such as selfie) by using a photographing apparatus such as a mobile phone or a camera, objects before a lens, such as the number of faces, a size of a face, a location of a face on a screen, a facial angle, and the like, can be captured by using the camera.

Step S311: Parse the collected photographing data to obtain a first attribute parameter, where the first attribute parameter includes the number of faces, a location of a face on a screen, and a size of a face in each location that are collected by the camera.

In specific implementation of this embodiment of the present disclosure, multiple graceful photographic pose recommendation pictures may be pre-stored in the photographing apparatus, parameters (the number of included faces, a location of a face on a screen, a size of a face in each location, a facial angle in each location, and the like) in each picture are defined, and the defined parameters are saved as a second attribute parameter of the picture.

In some feasible implementation manners, in the first attribute parameter, or the second attribute parameter, or the both, the location of a face on a screen may be a location scope. For example, the screen may be divided into multiple areas such as upper, lower, left, right and middle areas (for example, as shown in FIG. 2), or divided into other areas (for example, in FIG. 2.1, each box represents an area). In another feasible implementation manner, the location of a face on the screen may be specific location coordinates.

In some feasible implementation manners, in the first attribute parameter, or the second attribute parameter, or the both, the size of a face in each location may be represented by an interval range of the screen. For example, when the location of a face on the screen is an area, each area of the screen is divided into boxes of multiple sizes in the area scope, and each box represents an interval range. A box size may be used to represent the size of a face in each location. For example, as shown in FIG. 3, a middle area of the screen may be divided into five boxes: A1, A2, A3, A4, and A5, whose sizes are in ascending order. Therefore, the size of a face in the middle area location of the screen may be represented by A1, greater than A1 but less than A2, greater than A2 but less than A3, greater than A3 but less than A4, or greater than A4 but less than A5 (the size of the face in FIG. 4 is greater than A2 but less than A3). In some other feasible implementation manners, the size of a face in each location may also be represented by parameters, such as actual length, width/height. The facial angle may be an angle value, for example, frontal, full profile, or 45° profile; or the facial angle may be an angle range, for example, frontal, 0-45° left profile, or 0-45° right profile.

Certainly, in specific implementation, the location, size and angle of a face on a screen may also be represented in other manners, which are not enumerated herein exhaustively.

Step S312: Match the parsed-out number of faces to the number of faces included in one or more pre-stored photographic pose recommendation pictures.

In specific implementation, the number of faces collected by the camera may be one or more. For example, FIG. 7 shows a viewfinder frame in which the camera collects a single face; and FIG. 8 shows a viewfinder frame in which the camera collects two faces. With reference to FIG. 7 and FIG. 8, in step S312, matching is performed to determine whether there is a photographic pose recommendation picture including a single face or two faces.

Step S313: When a photographic pose recommendation picture in which the number of included faces is the same as the parsed-out number of faces is found, determine whether a location of each face on the screen in the photographic pose recommendation picture is the same as the parsed-out location of each face on the screen; if a determining result is that the location of each face on the screen in the photographic pose recommendation picture is the same as the parsed-out location of each face on the screen, perform step S314.

With reference to instances in FIG. 7 and FIG. 8, after a photographic pose recommendation picture including a single face or two faces is found in step S312, the photographic pose recommendation picture corresponding to a single face is shown in FIG. 9, and the photographic pose recommendation picture corresponding to two faces is shown in FIG. 10. Therefore, in step S313, it may be further determined whether the location of a face on the screen in FIG. 9 is the same as the location of a face on the screen in FIG. 7, and it may be determined whether the location of each face on the screen in FIG. 10 is the same as the location of each face on the screen in FIG. 8. Referring to FIG. 2, FIG. 7 and FIG. 9, it can be learned that, in the photographing data in FIG. 7, the location of a face on the screen is a middle area; and in the photographic pose recommendation picture in FIG. 9, the location of a face on the screen is also a middle area. It thus can be learned that the location of a single face on the screen in the photographic pose recommendation picture in FIG. 9 is the same as the location of a single face on the screen in the photographing data in FIG. 7.

In specific implementation, it is also possible that the photographic pose recommendation picture in FIG. 9 meets a matching requirement of the number of faces but does not meet a matching requirement of the location. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, referring to FIG. 2.1, FIG. 8 and FIG. 10, it can be learned that the locations of two faces on the screen in FIG. 8 respectively correspond to the locations shown in the diagram on the upper left side of FIG. 2.1, and the locations of two faces on the screen in FIG. 10 also correspond to the locations shown in the diagram on the upper left side of FIG. 2.1. Therefore, both the locations of the two faces on the screen in the photographic pose recommendation picture in FIG. 10 are the same as the locations of the two faces on the screen in the photographing data in FIG. 8.

In specific implementation, it is also possible that the photographic pose recommendation picture in FIG. 10 meets a matching requirement of the number of faces but does not meet a matching requirement of the location. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

Step S314: Determine whether a size of a face in each location in the photographic pose recommendation picture is the same as the parsed-out size of a face in each location; if a determining result is that the size of a face in each location in the photographic pose recommendation picture is the same as the parsed-out size of a face in each location, perform step S315.

Referring to FIG. 3, FIG. 7 and FIG. 9, it can be learned that the size of a single face in FIG. 7 is greater than A2 but less than A3, and the size of a single face in FIG. 9 is also greater than A2 but less than A3. Therefore, in step S315, it may be determined that a photographic pose recommendation picture shown in FIG. 9 is found, where a second attribute parameter of the photographic pose recommendation picture and the first attribute parameter obtained by parsing the photographing data in FIG. 7 meet a preset matching result.

In specific implementation, it is also possible that the photographic pose recommendation picture in FIG. 9 meets a matching requirement of the number of faces and meets a matching requirement of the location but does not meet a face size requirement. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, for FIG. 8 and FIG. 10, it may be determined separately whether sizes of single faces in same locations are the same between FIG. 8 and FIG. 10. If the sizes of single faces are the same, then in step S315, it may be determined that a photographic pose recommendation picture is found, where an attribute parameter of the photographic pose recommendation picture and the attribute parameter of the photographing data in FIG. 8 meet a preset matching result. If it is determined that a size of a face in one location in FIG. 8 is the same as a size of a face in a same location in FIG. 10, but a size of a face in another location is different from a size of a face in a same location in FIG. 10, it may be determined that a photographic pose recommendation picture is not found, where an attribute parameter of the photographic pose recommendation picture and the attribute parameter of the photographing data in FIG. 8 meet a preset matching result.

In specific implementation, it is also possible that the photographic pose recommendation picture in FIG. 10 meets a matching requirement of the number of faces and meets a matching requirement of the location but does not meet a face size requirement. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Step S315: Determine that a photographic pose recommendation picture is found, where a second attribute parameter of the photographic pose recommendation picture and the parsed-out first attribute parameter meet a preset matching result.

Step S316: When the photographic pose recommendation picture is found, output the photographic pose recommendation picture, where the second attribute parameter of the photographic pose recommendation picture and the parsed-out first attribute parameter meet the preset matching result.

In some feasible implementation manners, in step S316, the photographic pose recommendation picture may be superimposed in a semitransparent manner on the photographing data collected by the camera (as shown in FIG. 5.1, the frontal face is the photographing data collected by the camera, and the profile face is the photographic pose recommendation picture). On one hand, interference caused by the photographic pose recommendation picture to the photographing data collected by the camera can be reduced; on the other hand, it is convenient for the user to adjust his/her photographic pose by comparing the two pictures.

In some feasible implementation manners, multiple photographic pose recommendation pictures may meet the matching result. Therefore, in step S316, when multiple photographic pose recommendation pictures of which second attribute parameters match the first attribute parameter obtained by parsing the photographing data are found, one found photographic pose recommendation picture may be randomly output.

It can be seen from the foregoing that, in some feasible implementation manners, photographing data is collected by using a camera; the collected photographing data is parsed to obtain a first attribute parameter, where the first attribute parameter includes the number of faces, a location of a face on a screen, and a size of a face in each location that are collected by the camera; matching is performed between the parsed-out first attribute parameter and a second attribute parameter of one or more pre-stored photographic pose recommendation pictures; and when a photographic pose recommendation picture of which a second attribute parameter matches the parsed-out first attribute parameter is found, the found photographic pose recommendation picture is output, so that a user adjusts a photographic pose according to the photographic pose recommendation picture. In this way, a superb photographic pose recommendation picture can be output for a user.

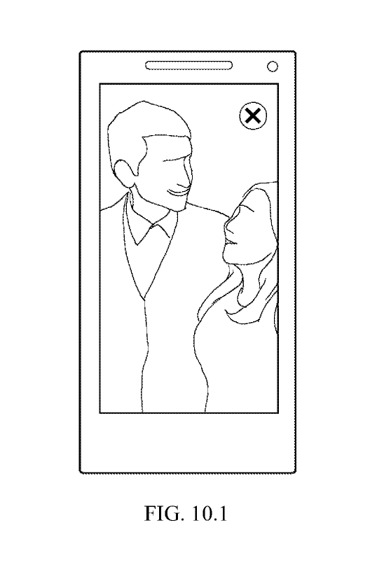

FIG. 12 is a schematic flowchart of Embodiment 4 of a picture outputting method according to the present disclosure. As shown in FIG. 12, the method may include the following steps. Step S410: Collect photographing data by using a camera.

In specific implementation, when a photo is taken (such as selfie) by using a photographing apparatus such as a mobile phone or a camera, objects before a lens, such as the number of faces, a size of a face, a location of a face on a screen, a facial angle, and the like, can be captured by using the camera.

Step S411: Parse the collected photographing data to obtain a first attribute parameter, where the first attribute parameter includes the number of faces, a location of a face on a screen, and a facial angle in each location that are collected by the camera.

In specific implementation of this embodiment of the present disclosure, multiple graceful photographic pose recommendation pictures may be pre-stored in the photographing apparatus, parameters (the number of included faces, a location of a face on a screen, a size of a face in each location, a facial angle in each location, and the like) in each picture are defined, and the defined parameters are saved as a second attribute parameter of the picture.

In some feasible implementation manners, in the first attribute parameter, or the second attribute parameter, or the both, the location of a face on a screen may be a location scope. For example, the screen may be divided into multiple areas such as upper, lower, left, right and middle areas (for example, as shown in FIG. 2), or divided into other areas (for example, in FIG. 2.1, each box represents an area). In another feasible implementation manner, the location of a face on the screen may be specific location coordinates.

In some feasible implementation manners, in the first attribute parameter, or the second attribute parameter, or the both, the size of a face in each location may be represented by an interval range of the screen. For example, when the location of a face on the screen is an area, each area of the screen is divided into boxes of multiple sizes in the area scope, and each box represents an interval range. A box size may be used to represent the size of a face in each location. For example, as shown in FIG. 3, a middle area of the screen may be divided into five boxes: A1, A2, A3, A4, and A5, whose sizes are in ascending order. Therefore, the size of a face in the middle area location of the screen may be represented by A1, greater than A1 but less than A2, greater than A2 but less than A3, greater than A3 but less than A4, or greater than A4 but less than A5 (the size of the face in FIG. 4 is greater than A2 but less than A3). In some other feasible implementation manners, the size of a face in each location may also be represented by parameters, such as actual length, width/height. The facial angle may be an angle value, for example, frontal, full profile, or 45° profile; or the facial angle may be an angle range, for example, frontal, 0-45° left profile, or 0-45° right profile.

Certainly, in specific implementation, the location, size and angle of a face on a screen may also be represented in other manners, which are not enumerated herein exhaustively.

Step S412: Match the parsed-out number of faces to the number of faces included in one or more pre-stored photographic pose recommendation pictures.

In specific implementation, the number of faces collected by the camera may be one or more. For example, FIG. 7 shows a viewfinder frame in which the camera collects a single face; and FIG. 8 shows a viewfinder frame in which the camera collects two faces. With reference to FIG. 7 and FIG. 8, in step S412, matching is performed to determine whether there is a photographic pose recommendation picture including a single face or two faces.

Step S413: When a photographic pose recommendation picture in which the number of included faces is the same as the parsed-out number of faces is found, determine whether a location of each face on the screen in the photographic pose recommendation picture is the same as the parsed-out location of each face on the screen; if a determining result is that the location of each face on the screen in the photographic pose recommendation picture is the same as the parsed-out location of each face on the screen, perform step S414.

With reference to instances in FIG. 7 and FIG. 8, after a photographic pose recommendation picture including a single face or two faces is found in step S412, the photographic pose recommendation picture corresponding to a single face is shown in FIG. 9, and the photographic pose recommendation picture corresponding to two faces is shown in FIG. 10. Therefore, in step S413, it may be further determined whether the location of a face on the screen in FIG. 9 is the same as the location of a face on the screen in FIG. 7, and it may be determined whether the location of each face on the screen in FIG. 10 is the same as the location of each face on the screen in FIG. 8. Referring to FIG. 2, FIG. 7 and FIG. 9, it can be learned that, in the photographing data in FIG. 7, the location of a face on the screen is a middle area; and in the photographic pose recommendation picture in FIG. 9, the location of a face on the screen is also a middle area. It thus can be learned that the location of a single face on the screen in the photographic pose recommendation picture in FIG. 9 is the same as the location of a single face on the screen in the photographing data in FIG. 7.

In specific implementation, it is also possible that the photographic pose recommendation picture in FIG. 9 meets a matching requirement of the number of faces but does not meet a matching requirement of the location. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, referring to FIG. 2.1, FIG. 8 and FIG. 10, it can be learned that the locations of two faces on the screen in FIG. 8 respectively correspond to the locations shown in the diagram on the upper left side of FIG. 2.1, and the locations of two faces on the screen in FIG. 10 also correspond to the locations shown in the diagram on the upper left side of FIG. 2.1. Therefore, both the locations of the two faces on the screen in the photographic pose recommendation picture in FIG. 10 are the same as the locations of the two faces on the screen in the photographing data in FIG. 8.

In specific implementation, it is also possible that the photographic pose recommendation picture in FIG. 10 meets a matching requirement of the number of faces but does not meet a matching requirement of the location. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

Step S414: Determine whether a facial angle in each location in the photographic pose recommendation picture is the same as the parsed-out facial angle in each location; if a determining result is that the facial angle in each location in the photographic pose recommendation picture is the same as the parsed-out facial angle in each location, perform step S415.

Referring to FIG. 7 and FIG. 9, it can be learned that the angle of a single face in FIG. 7 is frontal and the angle of a single face in FIG. 9 is 0-45° right profile, and therefore, it may be determined that the second attribute parameter of the photographic pose recommendation picture in FIG. 9 and the first attribute parameter obtained by parsing the photographing data in FIG. 7 do not meet a preset matching result.

In specific implementation, it is also possible that the photographic pose recommendation picture in FIG. 9 meets a matching requirement of the number of faces and meets a matching requirement of the location but does not meet a matching requirement of the facial angle. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, for FIG. 8 and FIG. 10, it may be determined separately whether facial angles of single faces in same location are the same between FIG. 8 and FIG. 10. If the facial angles of single faces are the same, in step S415, it may be determined that a photographic pose recommendation picture is found, where an attribute parameter of the photographic pose recommendation picture and the attribute parameter of the photographing data in FIG. 8 meet a preset matching result. If it is determined that a facial angle in one location in FIG. 8 is the same as a facial angle in a same location in FIG. 10, but a facial angle in another location is different from a facial angle in a same location in FIG. 10, it may be determined that the attribute parameter of the photographic pose recommendation picture in FIG. 10 and the attribute parameter of the photographing data in FIG. 8 do not meet a preset matching result.

In specific implementation, it is also possible that the photographic pose recommendation picture in FIG. 10 meets a matching requirement of the number of faces and meets a matching requirement of the location but does not meet a matching requirement of the facial angle. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

Step S415: Determine that a photographic pose recommendation picture is found, where a second attribute parameter of the photographic pose recommendation picture and the parsed-out attribute parameter meet a preset matching result.

Step S416: When the photographic pose recommendation picture is found, output the photographic pose recommendation picture, where the second attribute parameter of the photographic pose recommendation picture and the parsed-out first attribute parameter meet the preset matching result.

In some feasible implementation manners, In step S416, the photographic pose recommendation picture may be superimposed in a semitransparent manner on the photographing data collected by the camera (as shown in FIG. 5.1, the frontal face is the photographing data collected by the camera, and the profile face is the photographic pose recommendation picture). On one hand, interference caused by the photographic pose recommendation picture to the photographing data collected by the camera can be reduced; on the other hand, it is convenient for the user to adjust his/her photographic pose by comparing the two pictures.

In some feasible implementation manners, multiple photographic pose recommendation pictures may meet the matching result. Therefore, in step S416, when multiple photographic pose recommendation pictures of which attribute parameters match the attribute parameter of the photographing data are found, one found photographic pose recommendation picture may be randomly output.

It can be seen from the foregoing that, in some feasible implementation manners, photographing data is collected by using a camera; the collected photographing data is parsed to obtain a first attribute parameter, where the first attribute parameter includes the number of faces, a location of a face on a screen, and a size of a face in each location that are collected by the camera; matching is performed between the parsed-out first attribute parameter and a second attribute parameter of one or more pre-stored photographic pose recommendation pictures; and when a photographic pose recommendation picture of which a second attribute parameter matches the first attribute parameter obtained by parsing the photographing data is found, the found photographic pose recommendation picture is output, so that a user adjusts a photographic pose according to the photographic pose recommendation picture. In this way, a superb photographic pose recommendation picture can be output for a user.

Correspondingly, the present disclosure further provides an apparatus embodiment that may be used to implement the foregoing method embodiments.

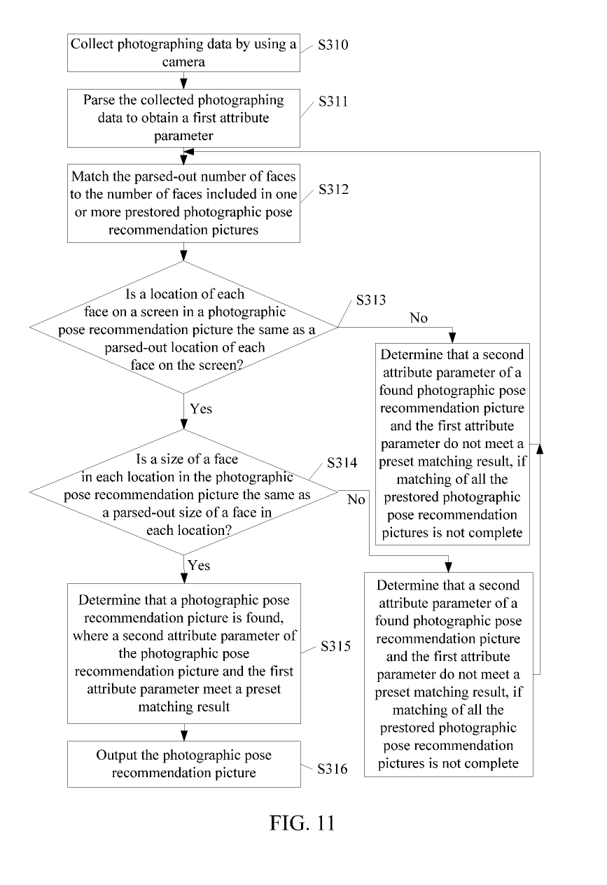

FIG. 13 is a schematic diagram of structural composition of Embodiment 1 of a picture outputting apparatus (in specific implementation, the picture outputting apparatus may be an apparatus that provides a photographing function, such as a camera) according to the present disclosure. As shown in FIG. 13, the picture outputting apparatus may include a photographing module 131 (which, in specific implementation, may be a video collecting apparatus such as a camera), a parsing module 132, a matching module 133, and a display output module 134, where the photographing module 131 is configured to collect photographing data, the parsing module 132 is configured to parse the photographing data collected by the photographing module 131 to obtain a first attribute parameter, where the first attribute parameter includes the number of faces and a location of a face on a screen that are collected by the photographing module 131, the matching module 133 is configured to match the first attribute parameter parsed out by the parsing module 132 to a second attribute parameter of one or more pre-stored photographic pose recommendation pictures, and the display output module 134 is configured to, when the matching module 133 finds a photographic pose recommendation picture, output the found photographic pose recommendation picture, so that a user adjusts a photographic pose according to the photographic pose recommendation picture, where a second attribute parameter of the photographic pose recommendation picture and the parsed-out first attribute parameter meet a preset matching result.

In specific implementation, when a photo is taken (such as selfie) by using a photographing apparatus such as a mobile phone or a camera, objects before a lens, such as the number of faces, a size of a face, a location of a face on a screen, a facial angle, and the like, can be captured by using the photographing module 131. Therefore, the parsing module 132 may parse the photographing data collected by the photographing module to obtain the corresponding first attribute parameter. In some feasible implementation manners, the first attribute parameter includes the number of faces and the location of a face on the screen that are collected by the photographing module. In some other embodiments, the first attribute parameter may further include a size of a face in each location, or a facial angle in each location, or the both, and the like.

In specific implementation of this embodiment of the present disclosure, multiple graceful photographic pose recommendation pictures may be pre-stored in the photographing apparatus, parameters (the number of included faces, a location of a face on a screen, a size of a face in each location, a facial angle in each location, and the like) in each picture are defined, and the defined parameters are saved as a second attribute parameter of the picture.

In some feasible implementation manners, in the first attribute parameter, or the second attribute parameter, or the both, the location of a face on a screen may be a location scope. For example, the screen may be divided into multiple areas such as upper, lower, left, right and middle areas (for example, as shown in FIG. 2). In another feasible implementation manner, the location of a face on the screen may be specific location coordinates.

Correspondingly, in some feasible implementation manners, in the first attribute parameter, or the second attribute parameter, or the both, the size of a face in each location may be represented by an interval range of the screen. For example, when the location of a face on the screen is a location scope of a divided area, each area of the screen is divided into boxes of multiple sizes, and each box represents an interval range. In this way, a box size may be used to represent the size of a face in each location. For example, as shown in FIG. 3, a middle area of the screen may be divided into five boxes: A1, A2, A3, A4, and A5, whose sizes are in ascending order. Therefore, the size of a face in the middle area location of the screen may be represented by A1, greater than A1 but less than A2, greater than A2 but less than A3, greater than A3 but less than A4, or greater than A4 but less than A5 (the size of the face in FIG. 4 is greater than A2 but less than A3). In some other feasible implementation manners, the size of a face in each location may also be represented by parameters, such as actual length, width/height.

Correspondingly, in the first attribute parameter, or the second attribute parameter, or the both, the facial angle in each location may be an angle value, for example, frontal, full profile, or 45° profile; or the facial angle may be an angle range, for example, frontal, 0-45° left profile, or 0-45° right profile.

Certainly, in specific implementation, the location, size and angle of a face on a screen may also be represented in other manners, which are not enumerated herein exhaustively.

The matching module 133 may match the first attribute parameter parsed out by the parsing module 132 to the second attribute parameter of the one or more pre-stored photographic pose recommendation pictures. In specific implementation, different matching rules may be set according to different parameter content that is included in the first attribute parameter and the second attribute parameter. A matching sequence of attribute parameter matching performed by the matching module 133 and a specific parameter that needs to be matched may be different, and standards for determining whether the preset matching result is met may also be different. For example, when the first attribute parameter and the second attribute parameter include the number of faces and the location of a face on a screen that are collected by the photographing module, parameters that need to be matched are only the number of faces and the location of a face on the screen. If the number of faces included in the photographing data is the same as the number of faces included in a photographic pose recommendation picture, and if a location of each face in the photographing data is also the same as a location of each face in the photographic pose recommendation picture, it may be determined that a photographic pose recommendation picture is found, where a second attribute parameter of the photographic pose recommendation picture and the first attribute parameter obtained by parsing the photographing data meet a preset matching result. However, when the first attribute parameter and the second attribute parameter include the number of faces, the location of a face on a screen, and the size of a face in each location that are collected by the photographing module, parameters that need to be matched by the matching module 133 are also the three. If the number of faces included in the photographing data is the same as the number of faces included in a photographic pose recommendation picture, the location of each face in the photographing data is also the same as a location of each face in the photographic pose recommendation picture, and the size of a face in each location in the photographing data is also the same as that in the photographic pose recommendation picture, it may be determined that a photographic pose recommendation picture is found, where a second attribute parameter of the photographic pose recommendation picture and the first attribute parameter obtained by parsing the photographing data meet a preset matching result. When the location of a face on a screen in the first attribute parameter and/or the second attribute parameter is specific location coordinates, and when matching is performed between the first attribute parameter and the second attribute parameter with regard to the location of a face on the screen, sameness of the location may refer to sameness of specific location coordinates; when the location of a face on a screen in the first attribute parameter and/or the second attribute parameter is a location scope, and when matching is performed between the first attribute parameter and the second attribute parameter with regard to the location of a face on the screen, sameness of the location may refer to being in a same location scope, for example, corresponding to FIG. 2, both being located on the left side, the right side, or the like of the screen. In specific implementation, when the size of a face in each location is represented by an interval range of the screen, and when matching is performed between the first attribute parameter and the second attribute parameter with regard to the size of a face in each location, sameness of the size may refer to being located in a same interval range of the screen. For example, corresponding to FIG. 4 (photographing data collected by the photographing module) and FIG. 5 (a pre-stored photographic pose recommendation picture), sameness of the size may refer to being located in a same interval in which the size is greater than A2 but less than A3. When the size of a face in each location is represented by parameters, such as actual length and width or height, and when matching is performed between the first attribute parameter and the second attribute parameter with regard to the size of a face in each location, sameness of the size may refer to sameness of length and width or height.

In some feasible implementation manners, the display output module 134 may superimpose the photographic pose recommendation picture in a semitransparent manner on the photographing data collected by the photographing module (as shown in FIG. 5.1, the frontal face is the photographing data collected by the photographing module, and the profile face is the photographic pose recommendation picture). On one hand, interference caused by the photographic pose recommendation picture to the photographing data collected by the photographing module can be reduced; on the other hand, it is convenient for the user to adjust his/her photographic pose by comparing the two pictures.

In some feasible implementation manners, multiple photographic pose recommendation pictures may meet the matching result. Therefore, when multiple photographic pose recommendation pictures of which attribute parameters match the attribute parameter of the photographing data are found, the display output module 134 may randomly output one found photographic pose recommendation picture.

It can be seen from the foregoing that, in some feasible implementation manners, photographing data is collected by using a photographing module; the collected photographing data is parsed to obtain a first attribute parameter, where the first attribute parameter includes the number of faces and a location of a face on a screen; matching is performed between the parsed-out first attribute parameter and a second attribute parameter of one or more prestored photographic pose recommendation pictures; and when a photographic pose recommendation picture is found, the photographic pose recommendation picture is output, so that a user adjusts a photographic pose according to the photographic pose recommendation picture, where a second attribute parameter of the photographic pose recommendation picture and the first attribute parameter meet a preset matching result. In this way, a superb photographic pose recommendation picture can be output for a user.

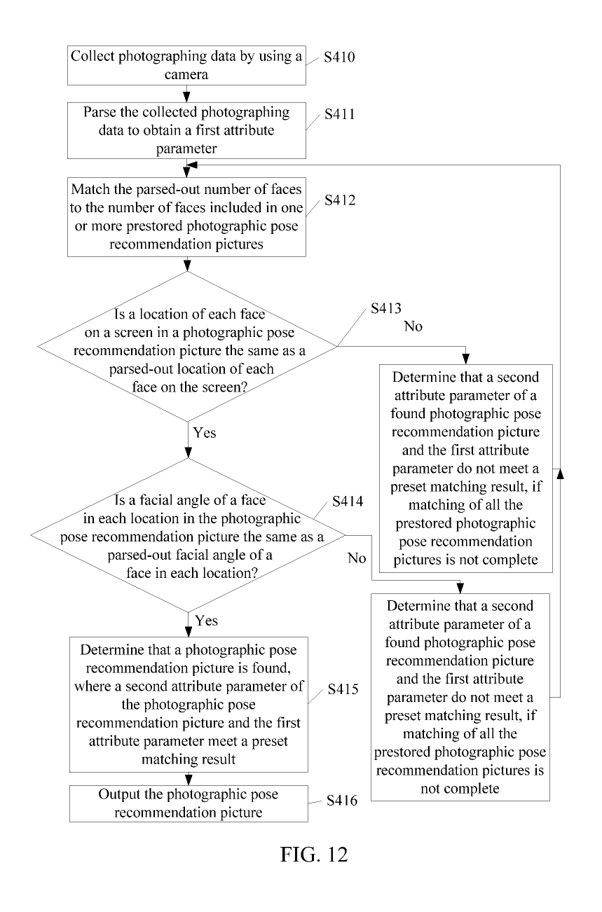

Further, referring to FIG. 14, as a feasible implementation manner, the matching module 133 in the present disclosure may include a first matching submodule 1331, a second matching submodule 1332, and a first determining submodule 1333.

The first matching submodule 1331 is configured to match the number of faces that is parsed out by the parsing module 132 to the number of faces included in the one or more pre-stored photographic pose recommendation pictures.

In specific implementation, the number of faces collected by the photographing module 131 may be one or more. For example, FIG. 7 shows a viewfinder frame in which the camera collects a single face; and FIG. 8 shows a viewfinder frame in which the camera collects two faces. With reference to FIG. 7 and FIG. 8, the first matching submodule 1331 performs matching to determine whether there is a photographic pose recommendation picture including a single face or two faces. After the photographic pose recommendation picture including a single face or two faces is found, corresponding to the single face in FIG. 7, the photographic pose recommendation picture in FIG. 9 is found, and corresponding to the two faces in FIG. 8, the photographic pose recommendation picture in FIG. 10 is found.

The second matching submodule 1332 is configured to, when the first matching submodule 1331 finds a photographic pose recommendation picture in which the number of included faces is the same as the number of faces that is parsed out by the parsing module 132, determine whether a location of each face on the screen in the photographic pose recommendation picture is the same as the location that is of a face on the screen and parsed out by the parsing module 132.

The first determining submodule 1333 is configured to, when a determining result of the second matching submodule 1332 is that the location of each face on the screen in the photographic pose recommendation picture is the same as the location that is of a face on the screen and parsed out by the parsing module 132, determine that a photographic pose recommendation picture is found, where a second attribute parameter of the photographic pose recommendation picture and the first attribute parameter parsed out by the parsing module 132 meet a preset matching result.

Still referring to the examples in FIG. 7 and FIG. 8, the second matching submodule 1332 may further determine whether the location of a face on the screen in FIG. 9 is the same as the location of a face on the screen in FIG. 7, and may determine whether the location of each face on the screen in FIG. 10 is the same as the location of each face on the screen in FIG. 8. Referring to FIG. 2, FIG. 7 and FIG. 9, it can be learned that, in the photographing data in FIG. 7, the location of a face on the screen is a middle area; and in the photographic pose recommendation picture in FIG. 9, the location of a face on the screen is also a middle area. It thus can be learned that the location of a single face on the screen in the photographic pose recommendation picture in FIG. 9 is the same as the location of a single face on the screen in the photographing data in FIG. 7. Therefore, for the photographing data in FIG. 7, the first determining submodule 1333 may determine that a photographic pose recommendation picture is found, where a second attribute parameter of the photographic pose recommendation picture and the first attribute parameter obtained by parsing the photographing data meet a preset matching result.

In specific implementation, it is also possible that the photographic pose recommendation picture in FIG. 9 meets a matching requirement of the number of faces but does not meet a matching requirement of the location. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, referring to FIG. 2.1, FIG. 8 and FIG. 10, it can be learned that the locations of two faces on the screen in FIG. 8 respectively correspond to the locations shown in the diagram on the upper left side of FIG. 2.1, and the locations of two faces on the screen in FIG. 10 also correspond to the locations shown in the diagram on the upper left side of FIG. 2.1. Therefore, both the locations of the two faces on the screen in the photographic pose recommendation picture in FIG. 10 are the same as the locations of the two faces on the screen in the photographing data in FIG. 8. Therefore, for the photographing data in FIG. 8, the first determining submodule 1333 may determine that a photographic pose recommendation picture is found, where a second attribute parameter of the photographic pose recommendation picture and the first attribute parameter obtained by parsing the photographing data meet a preset matching result.

In specific implementation, it is also possible that the photographic pose recommendation picture in FIG. 10 meets a matching requirement of the number of faces but does not meet a matching requirement of the location. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

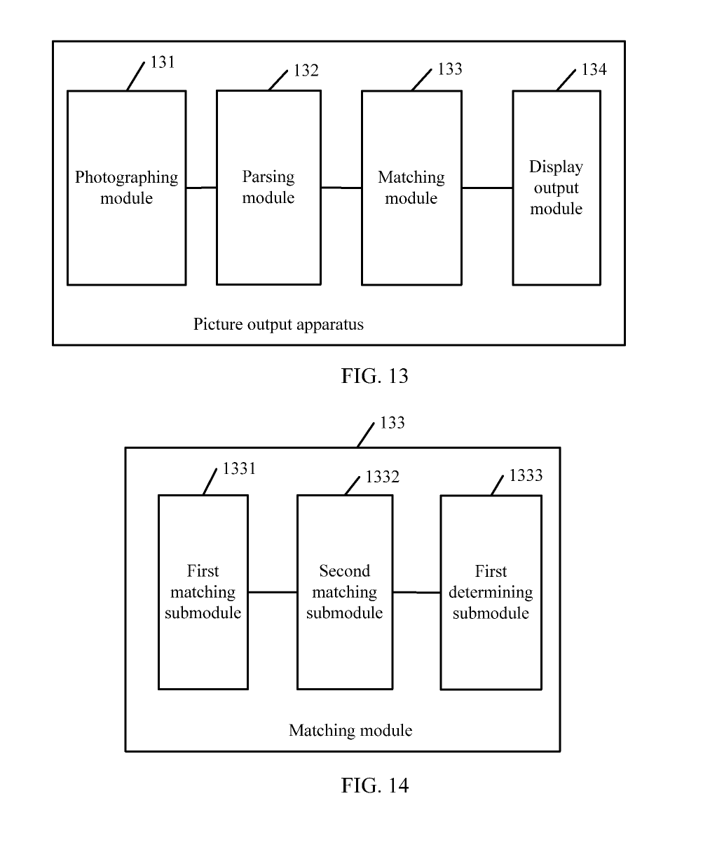

Further, referring to FIG. 15, as a feasible implementation manner, the matching module 133 in the present disclosure may include a first matching submodule 1331, a second matching submodule 1332, a third matching module 1335, and a second determining submodule 1336.

The first matching submodule 1331 is configured to match the number of faces that is parsed out by the parsing module 132 to the number of faces included in the one or more pre-stored photographic pose recommendation pictures.

In specific implementation, the number of faces collected by the photographing module 131 may be one or more. For example, FIG. 7 shows a viewfinder frame in which the camera collects a single face; and FIG. 8 shows a viewfinder frame in which the camera collects two faces. With reference to FIG. 7 and FIG. 8, the first matching submodule 1331 performs matching to determine whether there is a photographic pose recommendation picture including a single face or two faces. After the photographic pose recommendation picture including a single face or two faces is found, corresponding to the single face in FIG. 7, the photographic pose recommendation picture in FIG. 9 is found, and corresponding to the two faces in FIG. 8, the photographic pose recommendation picture in FIG. 10 is found.

The second matching submodule 1332 is configured to, when the first matching submodule 1331 finds a photographic pose recommendation picture in which the number of included faces is the same as the number of faces that is parsed out by the parsing module 132, determine whether a location of each face on the screen in the photographic pose recommendation picture is the same as the location that is of a face on the screen and parsed out by the parsing module 132.

Still referring to the examples in FIG. 7 and FIG. 8, the second matching submodule 1332 may further determine whether the location of a face on the screen in FIG. 9 is the same as the location of a face on the screen in FIG. 7, and may determine whether the location of each face on the screen in FIG. 10 is the same as the location of each face on the screen in FIG. 8. Referring to FIG. 2, FIG. 7 and FIG. 9, it can be learned that, in the photographing data in FIG. 7, the location of a face on the screen is a middle area; and in the photographic pose recommendation picture in FIG. 9, the location of a face on the screen is also a middle area. It thus can be learned that the location of a single face on the screen in the photographic pose recommendation picture in FIG. 9 is the same as the location of a single face on the screen in the photographing data in FIG. 7.

In specific implementation, it is also possible that the photographic pose recommendation picture in FIG. 9 meets a matching requirement of the number of faces but does not meet a matching requirement of the location. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, referring to FIG. 2.1, FIG. 8 and FIG. 10, it can be learned that the locations of two faces on the screen in FIG. 8 respectively correspond to the locations shown in the diagram on the upper left side of FIG. 2.1, and the locations of two faces on the screen in FIG. 10 also correspond to the locations shown in the diagram on the upper left side of FIG. 2.1. Therefore, both the locations of the two faces on the screen in the photographic pose recommendation picture in FIG. 10 are the same as the locations of the two faces on the screen in the photographing data in FIG. 8.

In specific implementation, it is also possible that the photographic pose recommendation picture in FIG. 10 meets a matching requirement of the number of faces but does not meet a matching requirement of the location. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

The third matching module 1335 is configured to, when a determining result of the second matching submodule 1332 is yes, determine whether a size of a face in each location in the photographic pose recommendation picture is the same as the size that is of a face in each location and parsed out by the parsing module 132.

The second determining submodule 1336 is configured to, when a determining result of the third matching module 1335 is yes, determine that a photographic pose recommendation picture is found, where a second attribute parameter of the photographic pose recommendation picture and the first attribute parameter parsed out by the parsing module 132 meet a preset matching result.

Referring to FIG. 3, FIG. 7 and FIG. 9, it can be learned that, after the matching is performed by the third matching module 1335, the size of a single face in FIG. 7 is greater than A2 but less than A3, and the size of a single face in FIG. 9 is also greater than A2 but less than A3. Therefore, the second determining submodule 1336 may determine that a photographic pose recommendation picture shown in FIG. 9 is found, where an attribute parameter of the photographic pose recommendation picture and the attribute parameter of the photographing data in FIG. 7 meet a preset matching result.

In specific implementation, it is also possible that the photographic pose recommendation picture in FIG. 9 meets a matching requirement of the number of faces and meets a matching requirement of the location but does not meet a matching requirement of the size of a face. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, for FIG. 8 and FIG. 10, the third matching module 1335 may determine separately whether sizes of single faces in same locations are the same between FIG. 8 and FIG. 10. If the sizes of single faces are the same, then the second determining submodule 1336 may determine that a photographic pose recommendation picture is found, where an attribute parameter of the photographic pose recommendation picture and the attribute parameter of the photographing data in FIG. 8 meet a preset matching result. If it is determined that a size of a face in one location in FIG. 8 is the same as a size of a face in a same location in FIG. 10, but a size of a face in another location is different from a size of a face in a same location in FIG. 10, it may be determined that the second attribute parameter of the photographic pose recommendation picture in FIG. 10 and the first attribute parameter obtained by parsing the photographing data in FIG. 8 do not meet a preset matching result.

In specific implementation, it is also possible that the photographic pose recommendation picture in FIG. 10 meets a matching requirement of the number of faces and meets a matching requirement of the location but does not meet a face size requirement. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

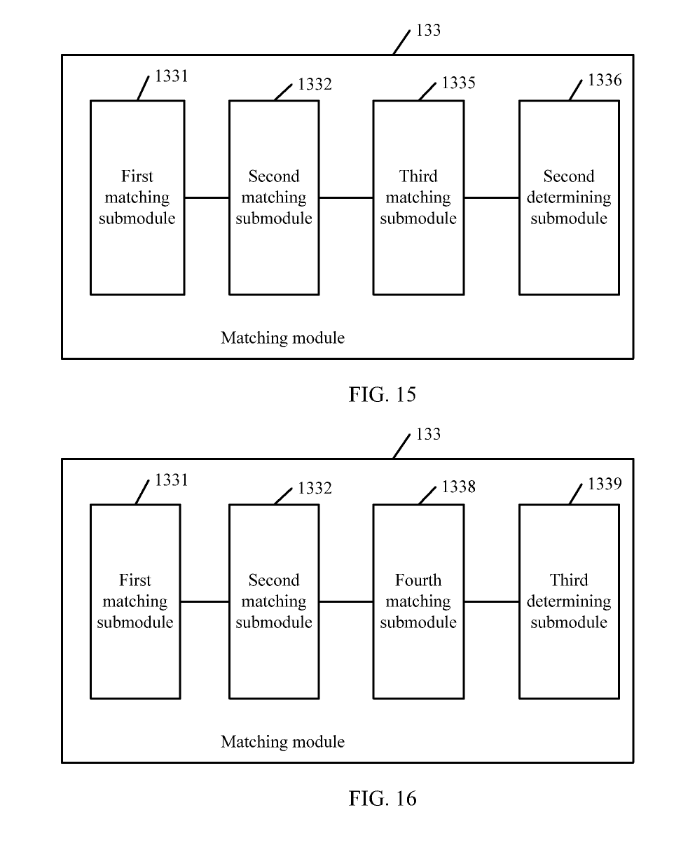

Further, referring to FIG. 16, as a feasible implementation manner, the matching module 133 in the present disclosure may include a first matching submodule 1331, a second matching submodule 1332, a fourth matching submodule 1338, and a third determining submodule 1339.

The first matching submodule 1331 is configured to match the number of faces that is parsed out by the parsing module 132 to the number of faces included in the one or more pre-stored photographic pose recommendation pictures.

In specific implementation, the number of faces collected by the photographing module 131 may be one or more. For example, FIG. 7 shows a viewfinder frame in which the camera collects a single face; and FIG. 8 shows a viewfinder frame in which the camera collects two faces. With reference to FIG. 7 and FIG. 8, the first matching submodule 1331 performs matching to determine whether there is a photographic pose recommendation picture including a single face or two faces. After the photographic pose recommendation picture including a single face or two faces is found, corresponding to the single face in FIG. 7, the photographic pose recommendation picture in FIG. 9 is found, and corresponding to the two faces in FIG. 8, the photographic pose recommendation picture in FIG. 10 is found.

The second matching submodule 1332 is configured to, when the first matching submodule 1331 finds a photographic pose recommendation picture in which the number of included faces is the same as the number of faces that is parsed out by the parsing module 132, determine whether a location of each face on the screen in the photographic pose recommendation picture is the same as the location that is of a face on the screen and parsed out by the parsing module 132.

Still referring to the examples in FIG. 7 and FIG. 8, the second matching submodule 1332 may further determine whether the location of a face on the screen in FIG. 9 is the same as the location of a face on the screen in FIG. 7, and may determine whether the location of each face on the screen in FIG. 10 is the same as the location of each face on the screen in FIG. 8. Referring to FIG. 2, FIG. 7 and FIG. 9, it can be learned that, in the photographing data in FIG. 7, the location of a face on the screen is a middle area; and in the photographic pose recommendation picture in FIG. 9, the location of a face on the screen is also a middle area. It thus can be learned that the location of a single face on the screen in the photographic pose recommendation picture in FIG. 9 is the same as the location of a single face on the screen in the photographing data in FIG. 7.

In specific implementation, it is also possible that the photographic pose recommendation picture in FIG. 9 meets a matching requirement of the number of faces but does not meet a matching requirement of the location. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, referring to FIG. 2.1, FIG. 8 and FIG. 10, it can be learned that the locations of two faces on the screen in FIG. 8 respectively correspond to the locations shown in the diagram on the upper left side of FIG. 2.1, and the locations of two faces on the screen in FIG. 10 also correspond to the locations shown in the diagram on the upper left side of FIG. 2.1. Therefore, both the locations of the two faces on the screen in the photographic pose recommendation picture in FIG. 10 are the same as the locations of the two faces on the screen in the photographing data in FIG. 8.

In specific implementation, it is also possible that the photographic pose recommendation picture in FIG. 10 meets a matching requirement of the number of faces but does not meet a matching requirement of the location. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

The fourth matching submodule 1338 is configured to, when a determining result of the second matching submodule 1332 is yes, determine whether a facial angle in each location in the photographic pose recommendation picture is the same as the facial angle that is of a face in each location and parsed out by the parsing module 132.

The third determining submodule 1339 is configured to, when a determining result of the fourth matching submodule 1338 is that the facial angle in each location in the photographic pose recommendation picture is the same as the facial angle that is of a face in each location and parsed out by the parsing module 132, determine that a photographic pose recommendation picture is found, where a second attribute parameter of the photographic pose recommendation picture and the first attribute parameter parsed out by the parsing module 132 meet a preset matching result.

Referring to FIG. 7 and FIG. 9, it can be learned that the angle of a single face in FIG. 7 is frontal and the angle of a single face in FIG. 9 is 0-45° right profile. According to determining of the facial angles of faces in FIG. 7 and FIG. 9, the fourth matching submodule 1338 may determine that the attribute parameter of the photographic pose recommendation picture in FIG. 9 and the attribute parameter of the photographing data in FIG. 7 do not meet a preset matching result.

In specific implementation, it is also possible that the photographic pose recommendation picture in FIG. 9 meets a matching requirement of the number of faces and meets a matching requirement of the location but does not meet a matching requirement of the facial angle. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, for FIG. 8 and FIG. 10, the fourth matching submodule 1338 may determine separately whether facial angles of single faces in same locations are the same between FIG. 8 and FIG. 10. If the facial angles of single faces are the same, the third determining submodule 1339 may determine that a photographic pose recommendation picture is found, where an attribute parameter of the photographic pose recommendation picture and the attribute parameter of the photographing data in FIG. 8 meet a preset matching result. If it is determined that a facial angle in one location in FIG. 8 is the same as a facial angle in a same location in FIG. 10, but a facial angle in another location is different from a facial angle in a same location in FIG. 10, it may be determined that the second attribute parameter of the photographic pose recommendation picture in FIG. 10 and the first attribute parameter obtained by parsing the photographing data in FIG. 8 do not meet a preset matching result.

In specific implementation, it is also possible that the photographic pose recommendation picture in FIG. 10 meets a matching requirement of the number of faces and meets a matching requirement of the location but does not meet a matching requirement of the facial angle. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

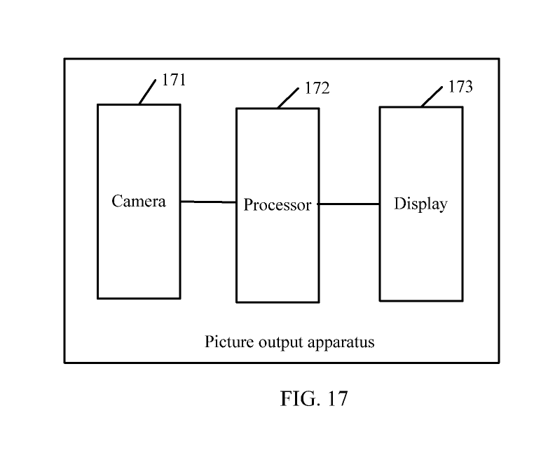

FIG. 17 is a schematic diagram of structural composition of Embodiment 2 of a picture outputting apparatus (in specific implementation, the picture outputting apparatus may be an apparatus that provides a photographing function, such as a camera) according to the present disclosure. As shown in FIG. 17, the picture outputting apparatus may include a camera 171, a processor 172, and a display 173.

The camera 171 is configured to collect photographing data.

In specific implementation, when a photo is taken (such as selfie) by using a photographing apparatus such as a mobile phone or a camera, objects before a lens, such as the number of faces, a size of a face, a location of a face on a screen, a facial angle, and the like, can be captured by using the camera 131.

The processor 172 is configured to parse the photographing data collected by the camera 171 to obtain a first attribute parameter, where the first attribute parameter includes the number of faces and the location of a face on a screen that are collected by the camera; and match the parsed-out first attribute parameter to a second attribute parameter of one or more prestored photographic pose recommendation pictures.

In some feasible implementation manners, the first attribute parameter includes the number of faces and the location of a face on the screen that are collected by the camera. In some other embodiments, the attribute parameter may further include a size of a face in each location, or a facial angle in each location, or the both, and the like.

In specific implementation of this embodiment of the present disclosure, multiple graceful photographic pose recommendation pictures may be pre-stored in the photographing apparatus, parameters (the number of included faces, a location of a face on a screen, a size of a face in each location, a facial angle in each location, and the like) in each picture are defined, and the defined parameters are saved as a second attribute parameter of the picture.

In some feasible implementation manners, in the first attribute parameter, or the second attribute parameter, or the both, the location of a face on a screen may be a location scope. For example, the screen may be divided into multiple areas such as upper, lower, left, right and middle areas (for example, as shown in FIG. 2). In another feasible implementation manner, the location of a face on the screen may be specific location coordinates.

Correspondingly, in some feasible implementation manners, in the first attribute parameter, or the second attribute parameter, or the both, the size of a face in each location may be represented by an interval range of the screen. For example, when the location of a face on the screen is a location scope of a divided area, each area of the screen is divided into boxes of multiple sizes, and each box represents an interval range. In this way, a box size may be used to represent the size of a face in each location. For example, as shown in FIG. 3, a middle area of the screen may be divided into five boxes: A1, A2, A3, A4, and A5, whose sizes are in ascending order. Therefore, the size of a face in the middle area location of the screen may be represented by A1, greater than A1 but less than A2, greater than A2 but less than A3, greater than A3 but less than A4, or greater than A4 but less than A5 (the size of the face in FIG. 4 is greater than A2 but less than A3). In some other feasible implementation manners, the size of a face in each location may also be represented by parameters, such as actual length, width/height.

Correspondingly, in some feasible implementation manners, in the first attribute parameter, or the second attribute parameter, or the both, the facial angle in each location may be an angle value, for example, frontal, full profile, or 45° profile; or the facial angle may be an angle range, for example, frontal, 0-45° left profile, or 0-45° right profile.

Certainly, in specific implementation, the location, size and angle of a face on a screen may also be represented in other manners, which are not enumerated herein exhaustively.

In specific implementation, different matching rules may be set according to different parameter content that is included in the first attribute parameter and the second attribute parameter. A matching sequence of attribute parameter matching performed by the processor 172 and a specific parameter that needs to be matched may be different, and standards for determining whether a preset matching result is met may also be different. For example, when the first attribute parameter and the second attribute parameter include the number of faces and the location of a face on a screen that are collected by the camera, parameters that need to be matched are only the number of faces and the location of a face on the screen. If the number of faces included in the photographing data is the same as the number of faces included in a photographic pose recommendation picture, and if a location of each face in the photographing data is also the same as a location of each face in the photographic pose recommendation picture, it may be determined that a photographic pose recommendation picture is found, where a second attribute parameter of the photographic pose recommendation picture and the first attribute parameter obtained by parsing the photographing data meet a preset matching result. However, when the first attribute parameter and the second attribute parameter include the number of faces, the location of a face on a screen, and the size of a face in each location that are collected by the camera, parameters that need to be matched by the processor 172 are also the three. If the number of faces included in the photographing data is the same as the number of faces included in a photographic pose recommendation picture, the location of each face in the photographing data is also the same as a location of each face in the photographic pose recommendation picture, and the size of a face in each location in the photographing data is also the same as that in the photographic pose recommendation picture, it may be determined that a photographic pose recommendation picture is found, where a second attribute parameter of the photographic pose recommendation picture and the first attribute parameter obtained by parsing the photographing data meet a preset matching result. In specific implementation, when the location of a face on a screen in the first attribute parameter and/or the second attribute parameter is specific location coordinates, and when matching is performed between the first attribute parameter and the second attribute parameter with regard to the location of a face on the screen, sameness of the location may refer to sameness of specific location coordinates; when the location of a face on a screen in the first attribute parameter and/or the second attribute parameter is a location scope, and when matching is performed between the first attribute parameter and the second attribute parameter with regard to the location of a face on the screen, sameness of the location may refer to being in a same location scope, for example, corresponding to FIG. 2, both being located on the left side, the right side, or the like of the screen. In specific implementation, when the size of a face in each location is represented by an interval range of the screen, and when matching is performed between the first attribute parameter and the second attribute parameter with regard to the size of a face in each location, sameness of the size may refer to being located in a same interval range of the screen. For example, corresponding to FIG. 4 (photographing data collected by the camera) and FIG. 5 (a pre-stored photographic pose recommendation picture), sameness of the size may refer to being located in a same interval in which the size is greater than A2 but less than A3. When the size of a face in each location is represented by parameters, such as actual length and width or height, and when matching is performed between the first attribute parameter and the second attribute parameter with regard to the size of a face in each location, sameness of the size may refer to sameness of length and width or height.

The display 173 is configured to, when the processor 172 finds a photographic pose recommendation picture, output the photographic pose recommendation picture, so that a user adjusts a photographic pose according to the photographic pose recommendation picture, where an attribute parameter of the photographic pose recommendation picture and the attribute parameter of the photographing data meet a preset matching result.

In some feasible implementation manners, the display 173 may superimpose the photographic pose recommendation picture in a semitransparent manner on the photographing data collected by the camera (as shown in FIG. 5.1, the bold line is the photographing data collected by the camera, and the fine line is the photographic pose recommendation picture). On one hand, interference caused by the photographic pose recommendation picture to the photographing data collected by the camera can be reduced; on the other hand, it is convenient for the user to adjust his/her photographic pose by comparing the two pictures.

In some feasible implementation manners, multiple photographic pose recommendation pictures may meet the matching result. Therefore, when multiple photographic pose recommendation pictures of which attribute parameters match the attribute parameter of the photographing data are found, the display 173 may randomly output one found photographic pose recommendation picture.

In some feasible implementation manners, the processor 172 is configured to: match the number of faces that is obtained by parsing the photographing data to the number of faces included in the one or more pre-stored photographic pose recommendation pictures; when a photographic pose recommendation picture in which the number of included faces is the same as the parsed-out number of faces is found, determine whether a location of each face on the screen in the photographic pose recommendation picture is the same as the parsed-out location of each face on the screen; and when it is determined that the location of each face on the screen in the photographic pose recommendation picture is the same as the parsed-out location of each face on the screen, determine that a photographic pose recommendation picture is found, where a second attribute parameter of the photographic pose recommendation picture and the first attribute parameter obtained by parsing the photographing data meet a preset matching result.

In specific implementation, the number of faces collected by the camera 171 may be one or more. For example, FIG. 7 shows a viewfinder frame in which the camera collects a single face; and FIG. 8 shows a viewfinder frame in which the camera collects two faces. With reference to FIG. 7 and FIG. 8, the processor 172 is configured to perform matching to determine whether there is a photographic pose recommendation picture including a single face or two faces. Corresponding to the single face in FIG. 7, the photographic pose recommendation picture in FIG. 9 is found, and corresponding to the two faces in FIG. 8, the photographic pose recommendation picture in FIG. 10 is found. After the photographic pose recommendation pictures in which the number of faces is matched, as shown in FIG. 9 and FIG. 10, are found, the processor 171 further determines whether the location of a face on the screen in FIG. 9 is the same as the location of a face on the screen in FIG. 7, and determines whether the location of each face on the screen in FIG. 10 is the same as the location of each face on the screen in FIG. 8. Referring to FIG. 2, FIG. 7 and FIG. 9, it can be learned that, in the photographing data in FIG. 7, the location of a face on the screen is a middle area; and in the photographic pose recommendation picture in FIG. 9, the location of a face on the screen is also a middle area. It thus can be learned that the location of a single face on the screen in the photographic pose recommendation picture in FIG. 9 is the same as the location of a single face on the screen in the photographing data in FIG. 7. Therefore, for the photographing data in FIG. 7, the processor 172 may determine that a photographic pose recommendation picture is found, where a second attribute parameter of the photographic pose recommendation picture and the first attribute parameter obtained by parsing the photographing data meet a preset matching result.

In specific implementation, it is also possible that the photographic pose recommendation picture in FIG. 9 meets a matching requirement of the number of faces but does not meet a matching requirement of the location. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, referring to FIG. 2.1, FIG. 8 and FIG. 10, it can be learned that the locations of two faces on the screen in FIG. 8 respectively correspond to the locations shown in the diagram on the upper left side of FIG. 2.1, and the locations of two faces on the screen in FIG. 10 also correspond to the locations shown in the diagram on the upper left side of FIG. 2.1. Therefore, both the locations of the two faces on the screen in the photographic pose recommendation picture in FIG. 10 are the same as the locations of the two faces on the screen in the photographing data in FIG. 8. Therefore, for the photographing data in FIG. 8, the processor 172 may determine that a photographic pose recommendation picture is found, where a second attribute parameter of the photographic pose recommendation picture and the first attribute parameter obtained by parsing the photographing data meet a preset matching result.

In specific implementation, it is also possible that the photographic pose recommendation picture in FIG. 10 meets a matching requirement of the number of faces but does not meet a matching requirement of the location. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

In some feasible implementation manners, the first attribute parameter includes the number of faces, the location of a face on the screen, and a size of a face in each location that are collected by the camera; and the processor 172 is configured to match the number of faces that is obtained by parsing the photographing data to the number of faces included in the one or more pre-stored photographic pose recommendation pictures; when a photographic pose recommendation picture in which the number of included faces is the same as the parsed-out number of faces is found, determine whether a location of each face on the screen in the photographic pose recommendation picture is the same as the parsed-out location of each face on the screen; when it is determined that the location of each face on the screen in the photographic pose recommendation picture is the same as the parsed-out location of each face on the screen, determine whether a size of a face in each location in the photographic pose recommendation picture is the same as the parsed-out size of a face in each location; and when it is determined that the size of a face in each location in the photographic pose recommendation picture and the size that is of a face in a same location and obtained by parsing the photographing data fall within a same size range, determine that a photographic pose recommendation picture is found, where a second attribute parameter of the photographic pose recommendation picture and the first attribute parameter obtained by parsing the photographing data meet a preset matching result.

In specific implementation, the number of faces collected by the camera 171 may be one or more. For example, FIG. 7 shows a viewfinder frame in which the camera collects a single face; and FIG. 8 shows a viewfinder frame in which the camera collects two faces. With reference to FIG. 7 and FIG. 8, the processor 172 is configured to perform matching to determine whether there is a photographic pose recommendation picture including a single face or two faces. Corresponding to the single face in FIG. 7, the photographic pose recommendation picture in FIG. 9 is found, and corresponding to the two faces in FIG. 8, the photographic pose recommendation picture in FIG. 10 is found.

Still referring to the examples in FIG. 7 and FIG. 8, after finding the photographic pose recommendation pictures including a single face or two faces, as shown in FIG. 9 and FIG. 10, the processor 172 may further determine whether the location of a face on the screen in FIG. 9 is the same as the location of a face on the screen in FIG. 7, and determine whether the location of each face on the screen in FIG. 10 is the same as the location of each face on the screen in FIG. 8. Referring to FIG. 2, FIG. 7 and FIG. 9, it can be learned that, in the photographing data in FIG. 7, the location of a face on the screen is a middle area; and in the photographic pose recommendation picture in FIG. 9, the location of a face on the screen is also a middle area. It thus can be learned that the location of a single face on the screen in the photographic pose recommendation picture in FIG. 9 is the same as the location of a single face on the screen in the photographing data in FIG. 7.

In specific implementation, it is also possible that the photographic pose recommendation picture in FIG. 9 meets a matching requirement of the number of faces but does not meet a matching requirement of the location. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, referring to FIG. 2.1, FIG. 8 and FIG. 10, it can be learned that the locations of two faces on the screen in FIG. 8 respectively correspond to the locations shown in the diagram on the upper left side of FIG. 2.1, and the locations of two faces on the screen in FIG. 10 also correspond to the locations shown in the diagram on the upper left side of FIG. 2.1. Therefore, both the locations of the two faces on the screen in the photographic pose recommendation picture in FIG. 10 are the same as the locations of the two faces on the screen in the photographing data in FIG. 8.

In specific implementation, it is also possible that the photographic pose recommendation picture in FIG. 10 meets a matching requirement of the number of faces but does not meet a matching requirement of the location. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

Referring to FIG. 3, FIG. 7 and FIG. 9, it can be learned that, according to the matching performed by the processor 172, the size of a single face in FIG. 7 is greater than A2 but less than A3, and the size of a single face in FIG. 9 is also greater than A2 but less than A3. Therefore, the processor 172 may determine that a photographic pose recommendation picture shown in FIG. 9 is found, where an attribute parameter of the photographic pose recommendation picture and the attribute parameter of the photographing data in FIG. 7 meet a preset matching result.

In specific implementation, it is also possible that the photographic pose recommendation picture in FIG. 9 meets a matching requirement of the number of faces and meets a matching requirement of the location but does not meet a matching requirement of the size of a face. In this case, a system may determine whether all the prestored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, for FIG. 8 and FIG. 10, the processor 172 may determine separately whether sizes of single faces in same locations are the same between FIG. 8 and FIG. 10. If the sizes of single faces are the same, then the processor 172 may determine that a photographic pose recommendation picture is found, where an attribute parameter of the photographic pose recommendation picture and the attribute parameter of the photographing data in FIG. 8 meet a preset matching result. If it is determined that a size of a face in one location in FIG. 8 is the same as a size of a face in a same location in FIG. 10, but a size of a face in another location is different from a size of a face in a same location in FIG. 10, it may be determined that the attribute parameter of the photographic pose recommendation picture in FIG. 10 and the attribute parameter of the photographing data in FIG. 8 do not meet a preset matching result.

In specific implementation, it is also possible that the photographic pose recommendation picture in FIG. 9 meets a matching requirement of the number of faces and meets a matching requirement of the location but does not meet a matching requirement of the size of a face. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

In some feasible implementation manners, the parsed-out attribute parameter includes the number of faces, the location of a face on the screen, and a facial angle in each location that are collected by the camera; therefore, the processor 172 is configured to match the number of faces that is obtained by parsing the photographing data to the number of faces included in the one or more pre-stored photographic pose recommendation pictures; when a photographic pose recommendation picture in which the number of included faces is the same as the parsed-out number of faces is found, determine whether a location of each face on the screen in the photographic pose recommendation picture is the same as the parsed-out location of each face on the screen; when it is determined that the location of each face on the screen in the photographic pose recommendation picture is the same as the parsed-out location of each face on the screen, determine whether a facial angle in each location in the photographic pose recommendation picture is the same as the parsed-out facial angle in each location; and when it is determined that the facial angle in each location in the photographic pose recommendation picture is the same as the parsed-out facial angle in each location, determine that a photographic pose recommendation picture is found, where a second attribute parameter of the photographic pose recommendation picture and the parsed-out attribute parameter meet a preset matching result.

In specific implementation, the number of faces collected by the camera 171 may be one or more. For example, FIG. 7 shows a viewfinder frame in which the camera collects a single face; and FIG. 8 shows a viewfinder frame in which the camera collects two faces. With reference to FIG. 7 and FIG. 8, the processor 172 is configured to perform matching to determine whether there is a photographic pose recommendation picture including a single face or two faces. Corresponding to the single face in FIG. 7, the photographic pose recommendation picture in FIG. 9 is found, and corresponding to the two faces in FIG. 8, the photographic pose recommendation picture in FIG. 10 is found.

Still referring to the examples in FIG. 7 and FIG. 8, after finding the photographic pose recommendation picture including a single face or two faces, the processor 172 may further determine whether the location of a face on the screen in FIG. 9 is the same as the location of a face on the screen in FIG. 7, and determine whether the location of each face on the screen in FIG. 10 is the same as the location of each face on the screen in FIG. 8. Referring to FIG. 2, FIG. 7 and FIG. 9, it can be learned that, in the photographing data in FIG. 7, the location of a face on the screen is a middle area; and in the photographic pose recommendation picture in FIG. 9, the location of a face on the screen is also a middle area. It thus can be learned that the location of a single face on the screen in the photographic pose recommendation picture in FIG. 9 is the same as the location of a single face on the screen in the photographing data in FIG. 7.

In specific implementation, it is also possible that the photographic pose recommendation picture in FIG. 9 meets a matching requirement of the number of faces but does not meet a matching requirement of the location. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, referring to FIG. 2.1, FIG. 8 and FIG. 10, it can be learned that the locations of two faces on the screen in FIG. 8 respectively correspond to the locations shown in the diagram on the upper left side of FIG. 2.1, and the locations of two faces on the screen in FIG. 10 also correspond to the locations shown in the diagram on the upper left side of FIG. 2.1. Therefore, both the locations of the two faces on the screen in the photographic pose recommendation picture in FIG. 10 are the same as the locations of the two faces on the screen in the photographing data in FIG. 8.

In specific implementation, it is also possible that the photographic pose recommendation picture in FIG. 10 meets a matching requirement of the number of faces but does not meet a matching requirement of the location. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

Referring to FIG. 7 and FIG. 9, it can be learned that the angle of a single face in FIG. 7 is frontal and the angle of a single face in FIG. 9 is 0-45° right profile. According to determining of the facial angles of faces in FIG. 7 and FIG. 9, the processor 172 may determine that the attribute parameter of the photographic pose recommendation picture in FIG. 9 and the attribute parameter of the photographing data in FIG. 7 do not meet a preset matching result.

In specific implementation, it is also possible that the photographic pose recommendation picture in FIG. 9 meets a matching requirement of the number of faces and meets a matching requirement of the location but does not meet a matching requirement of the facial angle. In this case, a system may determine whether all the pre-stored photographic pose recommendation pictures have been traversed. If a determining result is no, the system may proceed to invoke a next photographic pose recommendation picture to perform attribute parameter matching between the photographing data in FIG. 7 and the photographic pose recommendation picture until all the pre-stored photographic pose recommendation pictures are traversed.

Similarly, for FIG. 8 and FIG. 10, the processor 172 may determine separately whether facial angles of single faces in same locations are the same between FIG. 8 and FIG. 10. If the facial angles of single faces are the same, it may be determined that a photographic pose recommendation picture is found, where an attribute parameter of the photographic pose recommendation picture and the attribute parameter of the photographing data in FIG. 8 meet a preset matching result. If it is determined that a facial angle in one location in FIG. 8 is the same as a facial angle in a same location in FIG. 10, but a facial angle in another location is different from a facial angle in a same location in FIG. 10, it may be determined that the attribute parameter of the photographic pose recommendation picture in FIG. 10 and the attribute parameter of the photographing data in FIG. 8 do not meet a preset matching result.

In specific implementation, it is also possible that the photographic pose recommendation picture in FIG. 10 meets a matching requirement of the number of faces and meets a matching requirement of the location but does not meet a matching requirement of the facial angle. In this case, the system may determine whether all the pre-stored photographic pose recommendation pictures have been traversed. If a determining result is no, the system may proceed to invoke a next photographic pose recommendation picture to perform attribute parameter matching between the photographing data in FIG. 8 and the photographic pose recommendation picture until all the pre-stored photographic pose recommendation pictures are traversed.

It can be seen from the foregoing that, in some feasible implementation manners, photographing data is collected by using a camera; the collected photographing data is parsed to obtain a first attribute parameter, where the first attribute parameter includes the number of faces, a location of a face on a screen, and a facial angle in each location that are collected by the camera; matching is performed between the parsed-out first attribute parameter and a second attribute parameter of one or more pre-stored photographic pose recommendation pictures; and when a photographic pose recommendation picture of which a second attribute parameter matches the parsed-out first attribute parameter is found, the found photographic pose recommendation picture is output, so that a user adjusts a photographic pose according to the photographic pose recommendation picture. In this way, a superb photographic pose recommendation picture can be output for a user.

What is described above is merely exemplary embodiments of the present disclosure. However, the protection scope of the present disclosure is not limited thereto. Therefore, equivalent variations made according to the claims of the present disclosure shall fall within the scope of the present disclosure.

What is claimed is:

1. A picture outputting method, comprising:
collecting photographing data by using a camera;
parsing the photographing data to obtain a first attribute parameter, wherein the first attribute parameter indicates:
a number of faces; and
a location of a face on a screen;
matching the first attribute parameter to a second attribute parameter of one or more pre-stored photographic pose recommendation pictures; and
outputting the one or more pre-stored photographic pose recommendation pictures when the one or more pre-stored photographic pose recommendation pictures are found, so that a user adjusts a photographic pose according to the one or more pre-stored photographic pose recommendation pictures, wherein a second attribute parameter of the one or more pre-stored photographic pose recommendation pictures and the first attribute parameter meet a preset matching result.

2. The picture outputting method according to claim 1, wherein matching the first attribute parameter to the second attribute parameter of the one or more pre-stored photographic pose recommendation pictures comprises:
matching the number of faces indicated by the first attribute parameter to a number of faces comprised in the one or more pre-stored photographic pose recommendation pictures;
determining whether a location of each face on the screen in the one or more pre-stored photographic pose recommendation pictures is the same as the location of the face on the screen indicated by the first attribute parameter when the one or more pre-stored photographic pose recommendation pictures in which the number of faces comprised is the same as the number of faces indicated by the first attribute parameter are found; and
determining that the one or more pre-stored photographic pose recommendation pictures are found when a determining result is that a location of each face on the screen in the one or more pre-stored photographic pose recommendation picture is the same as the location of the face on the screen, wherein the second attribute parameter of the one or more pre-stored photographic pose recommendation pictures and the first attribute parameter meet the preset matching result.

3. The picture outputting method according to claim 1, wherein the first attribute parameter further comprises a size of a face in each location, and the matching the first attribute parameter to a second attribute parameter of one or more pre-stored photographic pose recommendation pictures comprises:
matching the number of faces indicated by the first attribute parameter to the number of faces comprised in the one or more pre-stored photographic pose recommendation pictures;
determining whether a location of each face on the screen in the one or more pre-stored photographic pose recommendation pictures is the same as the location of the face on the screen when the one or more pre-stored photographic pose recommendation pictures in which the number of faces comprised is the same as the number of faces indicated by the first attribute parameter are found;
determining whether the size of the face in each location in the photographic pose recommendation picture is the same as the size of the face in each location when a determining result is that a location of each face on the screen in the photographic pose recommendation picture is the same as the parsed-out location of a face on the screen; and
determining that the one or more pre-stored photographic pose recommendation picture are found when a determining result is that the size of the face in each location in the one or more pre-stored photographic pose recommendation pictures is the same as the size of the face in each location of the first attribute parameter, wherein the second attribute parameter of the one or more pre-stored photographic pose recommendation picture and the first attribute parameter meet the preset matching result.

4. The picture outputting method according to claim 1, wherein the first attribute parameter further comprises a facial angle in each location, and wherein matching the first attribute parameter to the second attribute parameter of the one or more pre-stored photographic pose recommendation pictures comprises:
matching the number of faces indicated by the first attribute parameter to the number of faces comprised in the one or more pre-stored photographic pose recommendation pictures;
determining whether a location of each face on the screen in the one or more pre-stored photographic pose recommendation picture is the same as the location of the face on the screen indicated by the first attribute parameter when the one or more pre-stored photographic pose recommendation pictures in which the number of faces comprised is the same as the number of faces indicated by the first attribute parameter are found;
determining whether a facial angle in each location in the one or more pre-stored photographic pose recommendation pictures is the same as the facial angle in each location indicated by the first attribute parameter when a first determining result is that the location of each face on the screen in the one or more pre-stored photographic pose recommendation pictures is the same as the location of the face on the screen indicated by the first attribute parameter; and
determining that the one or more pre-stored photographic pose recommendation pictures are found when a second determining result is that the facial angle in each location in the one or more pre-stored photographic pose recommendation picture is the same as the facial angle in each location indicated by the first attribute parameter, wherein the second attribute parameter of the one or more pre-stored photographic pose recommendation pictures and the first attribute parameter meet the preset matching result.

5. The picture outputting method according to claim 1, comprising outputting one of multiple pre-stored photographic pose recommendation pictures randomly when the multiple pre-stored photographic pose recommendation pictures of which the second attribute parameters match the first attribute parameter are found.

6. The picture outputting method according to claim 1, wherein outputting the one or more pre-stored photographic pose recommendation pictures comprises superimposing the one or more photographic pose recommendation pictures in a semitransparent manner on the photographing data collected by the camera.

7. A picture outputting apparatus, comprising:
a photographing module configured to collect photographing data;
a parsing module configured to parse the photographing data collected by the photographing module to obtain a first attribute parameter, wherein the first attribute parameter indicates:
a number of faces; and
a location of a face on a screen;
a matching module configured to match the first attribute parameter parsed out by the parsing module to a second attribute parameter of one or more pre-stored photographic pose recommendation pictures; and
a display output module configured to output the one or more pre-stored photographic pose recommendation pictures when the matching module finds the one or more pre-stored photographic pose recommendation pictures, so that a user adjusts photographic poses according to the one or more pre-stored photographic pose recommendation pictures, wherein a second attribute parameter of the one or more pre-stored photographic pose recommendation pictures and the first attribute parameter meet a preset matching result.

8. The picture outputting apparatus according to claim 7, wherein the matching module comprises:
a first matching submodule configured to match the number of faces indicated by the first attribute parameter to the number of faces comprised in the one or more pre-stored photographic pose recommendation pictures;
a second matching submodule configured to determine whether a location of each face on the screen in the one or more pre-stored photographic pose recommendation pictures is the same as the location of the face on the screen when the first matching submodule finds the one or more pre-stored photographic pose recommendation pictures in which the number of faces comprised is the same as the number of faces indicated by the first attribute parameter; and
a first determining submodule configured to determine that the one or more pre-stored photographic pose recommendation pictures are found, wherein the second attribute parameter of the one or more pre-stored photographic pose recommendation pictures and the first attribute parameter meet the preset matching result when a first determining result of the second matching submodule is that the location of each face on the screen in the one or more pre-stored photographic pose recommendation pictures is the same as the location of the face on the screen indicated by the first attribute parameter.

9. The picture outputting apparatus according to claim 7, wherein the first attribute parameter further comprises a size of a face in each location, and wherein the matching module comprises:
a first matching submodule configured to match the number of faces indicated by the first attribute parameter to the number of faces comprised in the one or more pre-stored photographic pose recommendation pictures;
a second matching submodule configured to determine whether a location of each face on the screen in the one or more pre-stored photographic pose recommendation picture is the same as the parsed-out location of a face on the screen when the first matching submodule finds the one or more pre-stored photographic pose recommendation pictures in which the number of faces comprised is the same as the number of faces indicated by the first attribute parameter;
a third matching submodule configured to determine whether the size of the face in each location in the one or more pre-stored photographic pose recommendation pictures is the same as the size of the face in each location indicated by the first attribute parameter when the first determining result of the second matching submodule is that the location of each face on the screen in the one or more pre-stored photographic pose recommendation pictures is the same as the location of the face on the screen indicated by the first attribute parameter; and
a second determining submodule configured to determine that the one or more pre-stored photographic pose recommendation pictures are found when a second determining result of the third matching module is that the size of the face in each location in the one or more pre-stored photographic pose recommendation pictures is the same as the size of the face in each location indicated by the first attribute parameter, wherein the second attribute parameter of the one or more photographic pose recommendation pictures and the first attribute parameter meet the preset matching result.

10. The picture outputting apparatus according to claim 7, wherein the first attribute parameter further comprises a facial angle in each location, and wherein the matching module comprises:
a first matching submodule configured to match the number of faces indicated by the first attribute parameter to the number of faces comprised in the one or more pre-stored photographic pose recommendation pictures;
a second matching submodule configured to determine whether a location of each face on the screen in the one or more photographic pose recommendation pictures is the same as the location of the face on the screen indicated by the first attribute parameter when the first matching submodule finds the one or more pre-stored photographic pose recommendation pictures in which the number of faces comprised is the same as the number of faces indicated by the first attribute parameter;
a fourth matching submodule configured to determine whether a facial angle in each location in the one or more pre-stored photographic pose recommendation pictures is the same as the facial angle in each location indicated by the first attribute parameter when a first determining result of the second matching submodule is that the location of each face on the screen in the one or more pre-stored photographic pose recommendation pictures is the same as the location of the face on the screen indicated by the first attribute parameter; and
a third determining submodule configured to determine that the one or more pre-stored photographic pose recommendation pictures are found when a second determining result of the fourth matching submodule is that the facial angle in each location in the one or more pre-stored photographic pose recommendation pictures is the same as the facial angle in each location indicated by the first attribute parameter, wherein the second attribute parameter of the one or more pre-stored photographic pose recommendation picture and the first attribute parameter meet the preset matching result.

11. The picture outputting apparatus according to claim 7, wherein the display output module is further configured to output one of multiple pre-stored photographic pose recommendation pictures randomly when the matching module finds the multiple photographic pose recommendation pictures of which the second attribute parameters match the first attribute parameter.

12. The picture outputting apparatus according to claim 7, wherein the display output module further configured to superimpose the one or more pre-stored photographic pose recommendation pictures in a semitransparent manner on the photographing data collected by the photographing module.

13. A picture outputting apparatus, comprising:
a camera configured to collect photographing data;
a processor configured to:
parse the photographing data collected by the camera to obtain a first attribute parameter, wherein the first attribute parameter indicates:
a number of faces; and
a location of a face on a screen; and
match the first attribute parameter to a second attribute parameter of one or more pre-stored photographic pose recommendation pictures; and
a display configured to output the one or more pre-stored photographic pose recommendation pictures when the processor finds the one or more pre-stored photographic pose recommendation pictures, so that a user adjusts a photographic pose according to the one or more photographic pose recommendation pictures, wherein a second attribute parameter of the one or more photographic pose recommendation pictures and the first attribute parameter meet a preset matching result.

14. The picture outputting apparatus according to claim 13, wherein when matching the first attribute parameter to the second attribute parameter of the one or more pre-stored photographic pose recommendation pictures, the processor is further configured to:
match the number of faces indicated by the first attribute parameter to the number of faces comprised in the one or more pre-stored photographic pose recommendation pictures;
determine whether a location of each face on the screen in the one or more pre-stored photographic pose recommendation pictures is the same as the location of the face on the screen indicated by the first attribute parameter when the one or more photographic pose recommendation pictures in which the number of faces comprised is the same as the number of faces indicated by the first attribute parameter are found; and
determine that the one or more pre-stored photographic pose recommendation picture are found when a first determining result is that the location of each face on the screen in the one or more pre-stored photographic pose recommendation pictures is the same as the location of the face on the screen indicated by the first attribute parameter, wherein the second attribute parameter of the one or more photographic pose recommendation pictures found by the processor and the first attribute parameter meet the preset matching result.

15. The picture outputting apparatus according to claim 13, wherein the first attribute parameter further comprises a size of a face in each location, and wherein when matching the first attribute parameter to the second attribute parameter of the one or more pre-stored photographic pose recommendation pictures, the processor is further configured to:
match the number of faces indicated by the first attribute parameter to the number of faces comprised in the one or more pre-stored photographic pose recommendation pictures;
determine whether a location of each face on the screen in the one or more photographic pose recommendation pictures is the same as the location of the face on the screen indicated by the first attribute parameter when the one or more pre-stored photographic pose recommendation picture in which the number of faces comprised is the same as the number of faces indicated by the first attribute parameter are found;
determine whether the size of the face in each location in the one or more pre-stored photographic pose recommendation pictures is the same as the size of the face in each location indicated by the first attribute parameter when a first determining result is that the location of each face on the screen in the one or more pre-stored photographic pose recommendation pictures is the same as the location of the face on the screen indicated by the first attribute parameter; and
determine that the one or more pre-stored photographic pose recommendation picture are found when a second determining result is that the size of the face in each location in the one or more pre-stored photographic pose recommendation picture is the same as the size of the face in each location indicated by the first attribute parameter, wherein the second attribute parameter of the one or more pre-stored photographic pose recommendation pictures found by the processor and the first attribute parameter meet the preset matching result.

16. The picture outputting apparatus according to claim 13, wherein the first attribute parameter further comprises a facial angle in each location, and wherein when matching the first attribute parameter to the second attribute parameter of the one or more pre-stored photographic pose recommendation pictures, the processor is further configured to:
match the number of faces indicated by the first attribute parameter to the number of faces comprised in the one or more pre-stored photographic pose recommendation pictures;
determine whether a location of each face on the screen in the one or more pre-stored photographic pose recommendation pictures is the same as the location of the face on the screen indicated by the first attribute parameter when the one or more pre-stored photographic pose recommendation pictures in which the number of faces comprised is the same as the number of faces indicated by the first attribute parameter are found;
determine whether the facial angle in each location in the one or more photographic pose recommendation pictures is the same as the facial angle in each location indicated by the first attribute parameter when a first determining result is that the location of each face on the screen in the one or more pre-stored photographic pose recommendation pictures is the same as the location of the face on the screen indicated by the first attribute parameter; and
determine that the one or more pre-stored photographic pose recommendation pictures are found when a second determining result is that the facial angle in each location in the one or more pre-stored photographic pose recommendation pictures is the same as the facial angle in each location indicated by the first attribute parameter, wherein the second attribute parameter of the one or more photographic pose recommendation picture found by the processor and the first attribute parameter meet the preset matching result.

17. The picture outputting apparatus according to claim 13, wherein the display is configured to output one of multiple pre-stored photographic pose recommendation pictures randomly when the processor finds the multiple photographic pose recommendation pictures of which the second attribute parameters match the first attribute parameter.

18. The picture outputting apparatus according to claim 13, wherein the display is further configured to superimpose the one or more photographic pose recommendation pictures found by the processor in a semitransparent manner on the photographing data collected by the camera.
